(19) United States
(12) Patent Application Publication
(10) Pub. No.: US 2016/0004030 A1
(43) Pub. Date: Jan. 7, 2016

(54) LENS BARREL, IMAGING DEVICE, AND PART OF LENS BARREL

(71) Applicant: OLYMPUS CORPORATION, Tokyo (JP)

(72) Inventors: Kohei SHIRAMIZU, Kawasaki-shi (JP); Keita TAKAHASHI, Sagamihara-shi (JP); Kunihisa OBI, Tokyo (JP)

(73) Assignee: OLYMPUS CORPORATION, Tokyo (JP)

(21) Appl. No.: 14/853,301

(22) Filed: Sep. 14, 2015

Related U.S. Application Data
(63) Continuation of application No. PCT/JP2014/062858, filed on May 14, 2014.

(30) Foreign Application Priority Data
Aug. 21, 2013 (JP) 2013-171279

(51) Int. Cl. G02B 7/10; G02B 7/02

(52) U.S. Cl. CPC G02B 7/10; G02B 7/021

(57) ABSTRACT

A lens barrel is provided that accommodates an optical member including a lens so as to be movable in an optical axis direction. The lens barrel includes a first part that is molded from a resin material in which an additive with a friction-reducing property is added to a base resin, and thereby the additive is exposed on the surface of the base resin. The first part moves along with the movement of the optical member in the optical axis direction. The lens barrel also includes a second part that comes into contact with the first part, and slides relative to a surface of the first part on which the additive is exposed along with the movement of the optical member moves in the optical axis direction.

This application is a continuation application based on PCT/JP2014/062858, filed on May 14, 2014 and claiming priority based on Japanese Patent Application No. 2013-171279, filed in Japan on Aug. 21, 2013. The contents of both the Japanese Patent Application and the PCT Application are incorporated herein by reference.

### BACKGROUND OF THE INVENTION

1. Field of the Invention

The present invention relates to a lens barrel, an imaging device comprising the lens barrel, and a part of the lens barrel.

2. Description of Related Art

In the related art, as lens barrels to be used in cameras or the like that perform photographing, a collapsible type lens barrel extendable over its entire length between a photography-enabled state and a collapsed state has been put into practical use and has been widely prevalent (for example, refer to Japanese Patent Application Publication No. 2010-262177.) In the photography-enabled state, this lens barrel assumes a form where the lens barrel is extended in an optical axis direction, protruding forwardly from a front surface of a housing of a camera to which the lens barrel is secured. Additionally, in the collapsed state, the lens barrel assumes a form in which the lens barrel is shortened in the optical axis direction compared to the photography-enabled state and accommodated within the housing of the camera.

In such a lens barrel, when a rotary frame is rotated from the collapsed state, for example, the rotary frame and a cam frame are moved to their wide positions in the photography-enabled state while rotating, and a first group frame, a second group frame, and a shutter/third group unit are moved to their wide positions in the photography-enabled state in a rotation-restricted manner. Then, when the rotary frame is rotated further from its wide positions, the rotary frame stays at a present position without moving forward and backward. Additionally, the cam frame rotates and moves to its telephoto position, and the first group frame, the second group frame, and the shutter/third group unit are moved to their telephoto positions, respectively, in a rotation-restricted manner.

Additionally, the lens barrel is driven for zooming and focusing operations other than the collapsing operation.

Motors (a DC motor and a stepping motor) can be used for driving of such a lens barrel.

### SUMMARY OF THE INVENTION

According to a first aspect of the present invention, a lens barrel accommodating an optical member including a lens such that the optical member is movable in a direction of an optical axis of the optical member is provided. The lens barrel at least includes a first part configured to move when the optical member moves in the direction of the optical axis, the first part being molded of a resin material in which an additive including organosilicon compound with a friction-reducing property is added to a base resin, the additive being exposed on a surface of the base resin; and a second part being in contact with the surface of the first part, the second part relatively sliding on the surface of the first part when the optical member moves in the direction of the optical axis.

According to a lens barrel of a second aspect of the present invention based on the above first aspect, the first part can be a lens frame that secures the lens, or a part being into contact with the lens frame.

According to a lens barrel of a third aspect of the present invention based on the above first aspect or the above second aspect, the additive contains organosilicone.

According to a lens barrel of a fourth aspect of the present invention based on any one of the above first aspect to the above third aspect, the second part may be molded of a resin material in which an additive with a friction-reducing property is added to a base resin, and the additive can be exposed on a surface of the base resin.

According to a lens barrel of a fifth aspect of the present invention based on any one of the above first aspect to the above fourth aspect, the base resin may contain at least one of polycarbonate and polyamide.

According to a lens barrel of a sixth aspect of the present invention based on any one of the above first aspect to the above fifth aspect, a coefficient of dynamic friction of the first part under a load of 20 g can be equal to or lower than 0.2.

According to a lens barrel of a seventh aspect of the present invention based on any one of the above first aspect to the above sixth aspect, a bending elastic modulus of the first part can be equal to or higher than 6 GPa.

According to an eighth aspect of the present invention, an imaging device can be provided including the lens barrel of any one aspect of the above first aspect to the above seventh aspect.

According to a ninth aspect of the present invention, a part for a lens barrel can be provided that accommodates an optical member including a lens such that the optical member is movable in a direction of an optical axis of the optical member, the part is made of a material including a base resin, an additive having a friction-reducing property is added to a base resin and the additive is exposed on a surface of the base resin, and

wherein, being accommodated in the lens barrel, the part is in contact with another part of the lens barrel on the surface on which the additive is exposed, the another part relatively slides on the part when the optical member moves in a direction of the optical axis.

According to a lens barrel of a tenth aspect of the present invention based on the above ninth aspect, the surface of the part of the lens barrel can be configured such that a coefficient of dynamic friction under a load of 20 g is equal to or lower than 0.2.

According to an eleventh aspect of the present invention, a lens barrel can be provided that accommodates an optical member including a lens such that the optical member is movable in a direction of an optical axis of the optical member. The lens barrel has a plurality of sliding parts that slides on another part when the optical member moves in a direction of the optical axis and that made of resin, at least one of the plurality of sliding parts is formed by adding an additive to the resin such that a coefficient of dynamic friction of a surface of the at least one of sliding parts becomes equal to or lower than 0.2 under a load of 20 g, and no lubricant is applied on the surface of the at least one of sliding parts.

According to a lens barrel of a twelfth aspect of the present invention based on any one of the above first aspect to the above seventh aspect, a lubricant does not have to be applied on a sliding surface on which the first part and the second part slide against each other.

According to a lens barrel of a thirteenth aspect of the present invention based on the above twelfth aspect, at least portions of the sliding surface on which the first part and the second part slide against each other with the movement of the optical member in a direction of the optical axis of the optical member may be exposed to the optical member.

According to a lens barrel of a fourteenth aspect of the present invention based on any one of the above first aspect to the above seventh aspect, the above twelfth aspect, and the above thirteenth aspect, the first part may not be exposed to the outside of the lens barrel.

### SUMMARY OF THE INVENTION

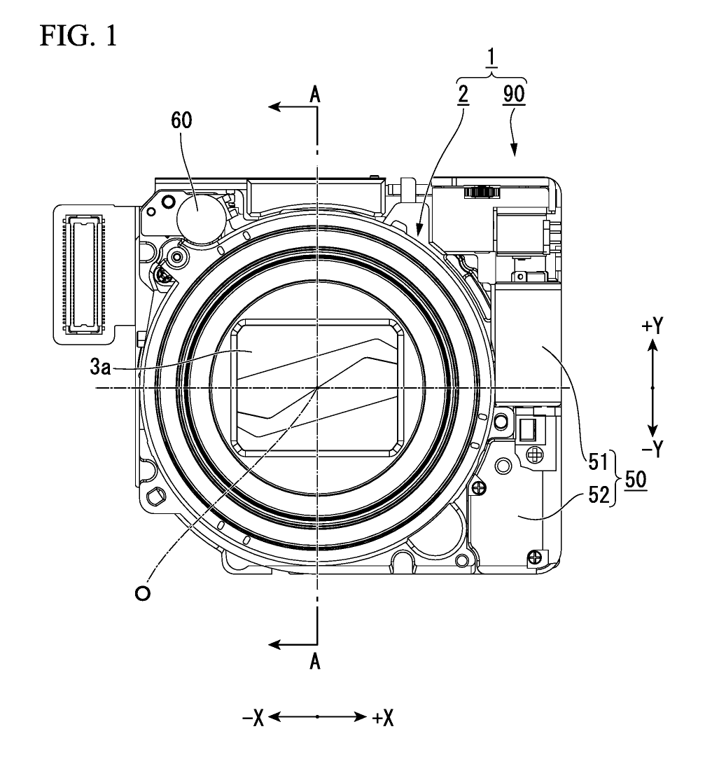

FIG. 1 is a schematic front view of a lens barrel of a first embodiment of the present invention.

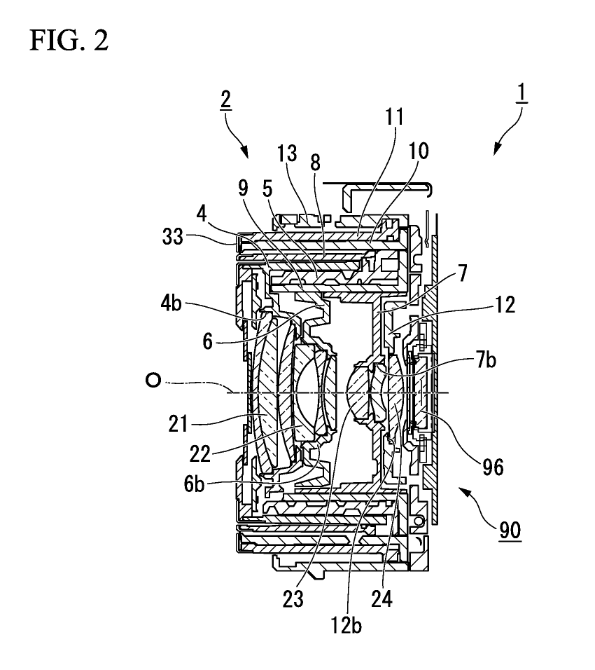

FIG. 2 is a sectional view taken along line A-A in FIG. 1.

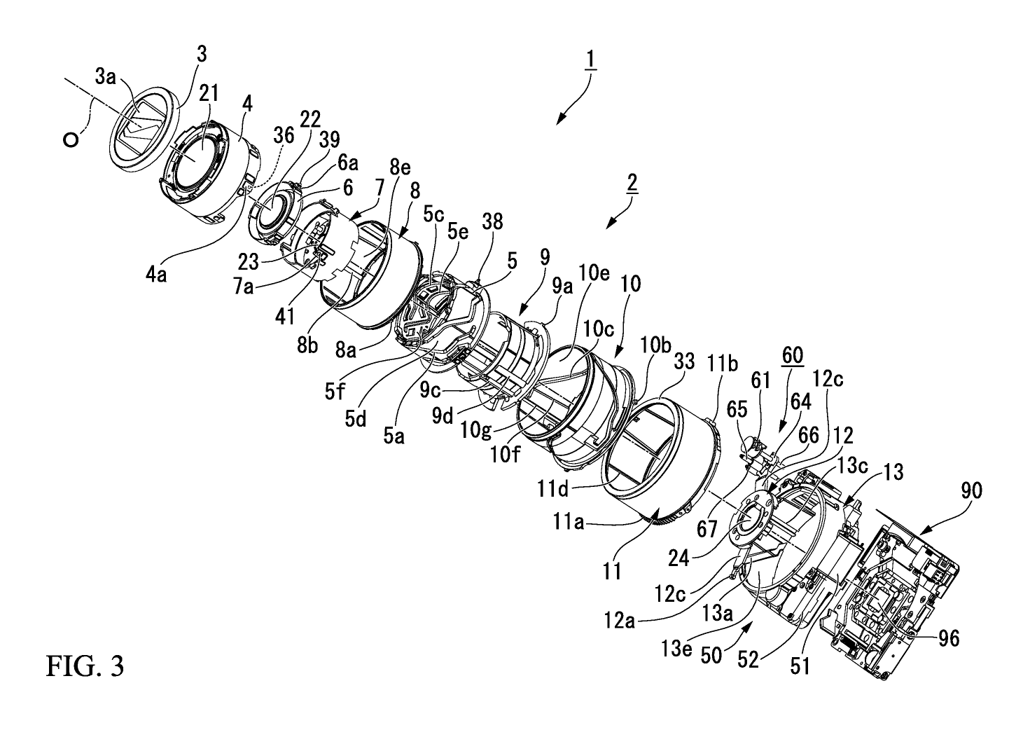

FIG. 3 is a schematic exploded perspective view showing a portion of the lens barrel of the first embodiment of the present invention.

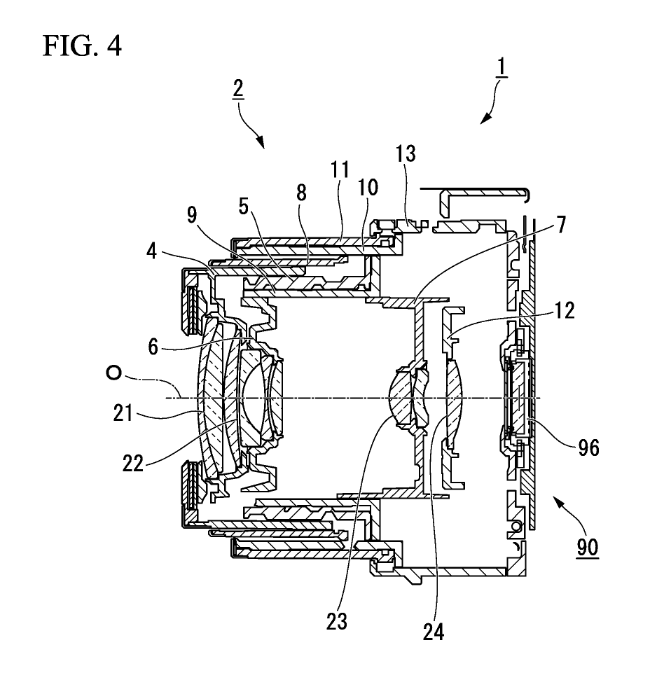

FIG. 4 is a schematic sectional view including an optical axis in a wide state of the lens barrel of the first embodiment of the present invention.

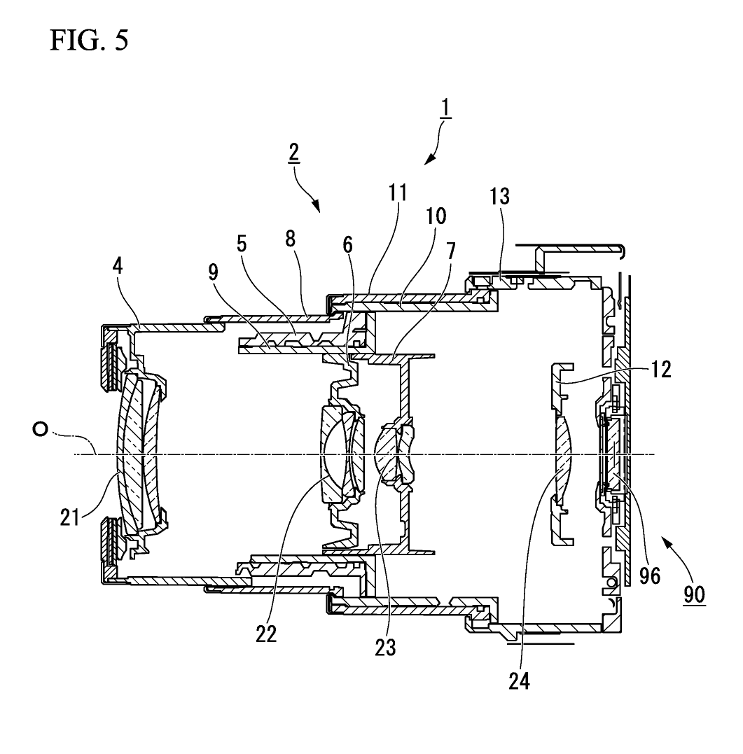

FIG. 5 is a schematic sectional view including the optical axis in a telephoto state of the lens barrel of the first embodiment of the present invention.

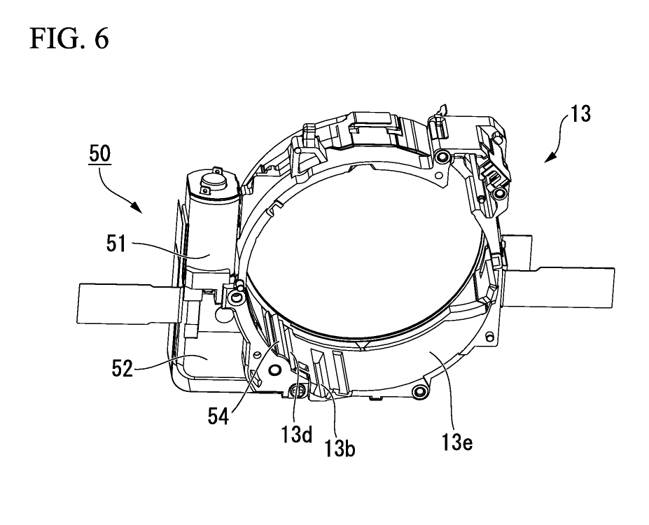

FIG. 6 is a schematic perspective view of a fixed frame of the lens barrel of the first embodiment of the present invention.

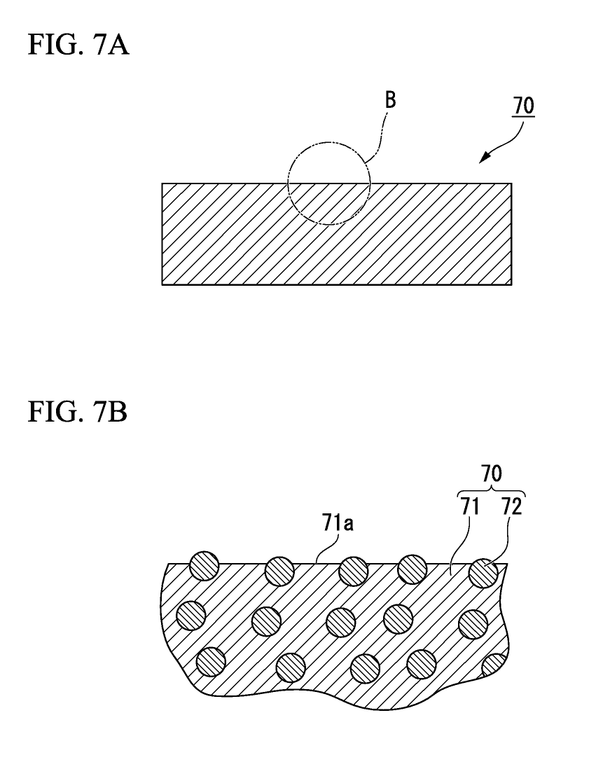

FIG. 7A is a schematic sectional view of a sliding resin molding product that can be used for the lens barrel of the first embodiment of the present invention.

FIG. 7B is an enlarged view of portion B of FIG. 7A.

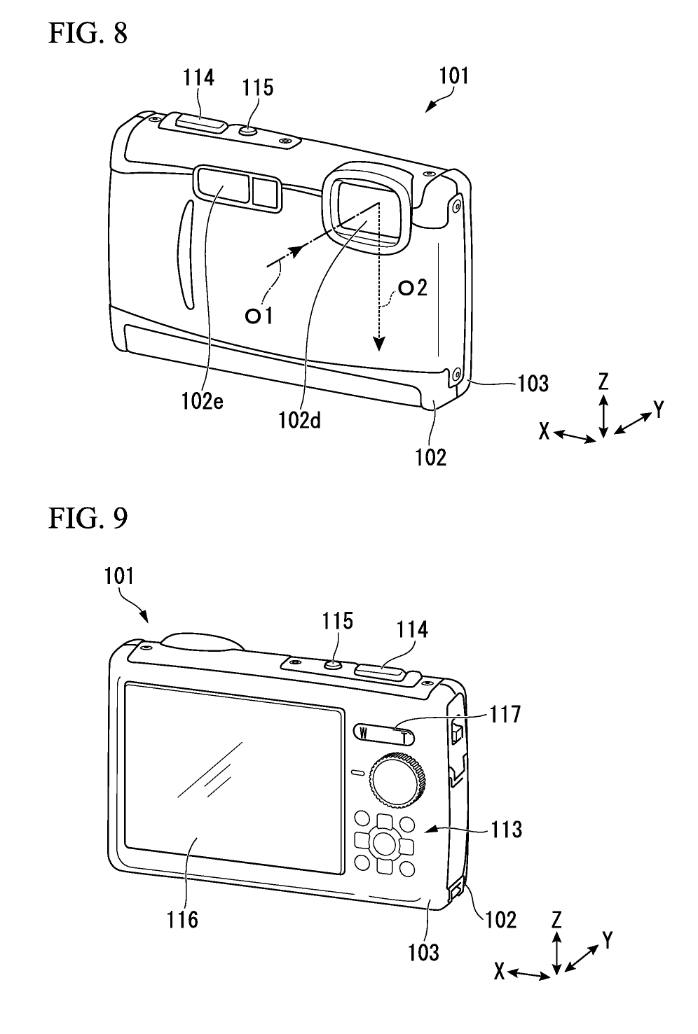

FIG. 8 is a schematic perspective view showing an external appearance as viewed from a front surface side of an imaging device of a second embodiment of the present invention.

FIG. 9 is a schematic perspective view showing an external appearance as viewed from a rear surface side of the imaging device of the second embodiment of the present invention.

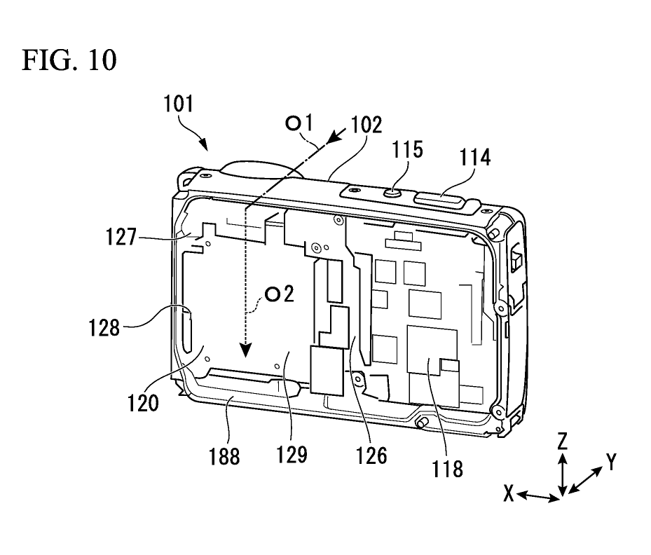

FIG. 10 is a schematic perspective view showing an internal arrangement on the rear surface side of the imaging device of the second embodiment of the present invention.

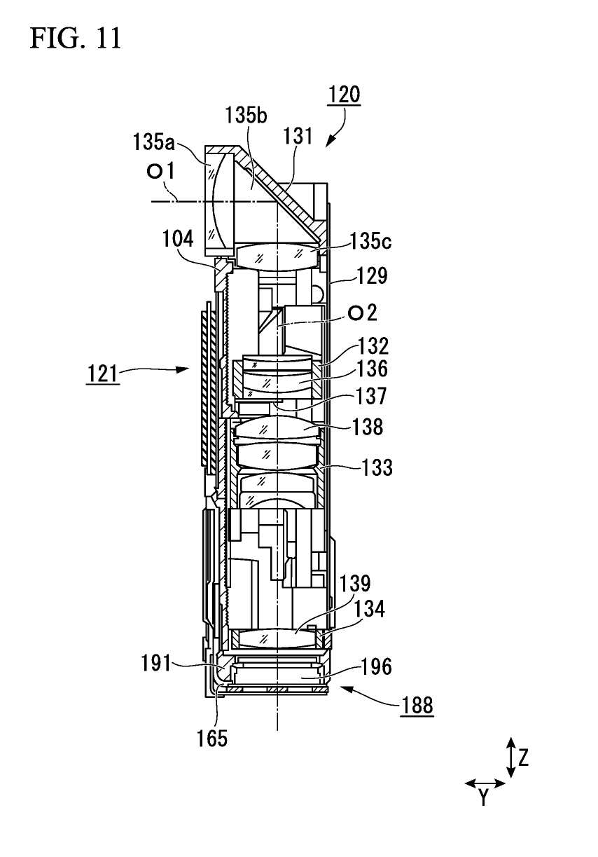

FIG. 11 is a schematic sectional view, including an optical axis, of a lens barrel of the second embodiment of the present invention.

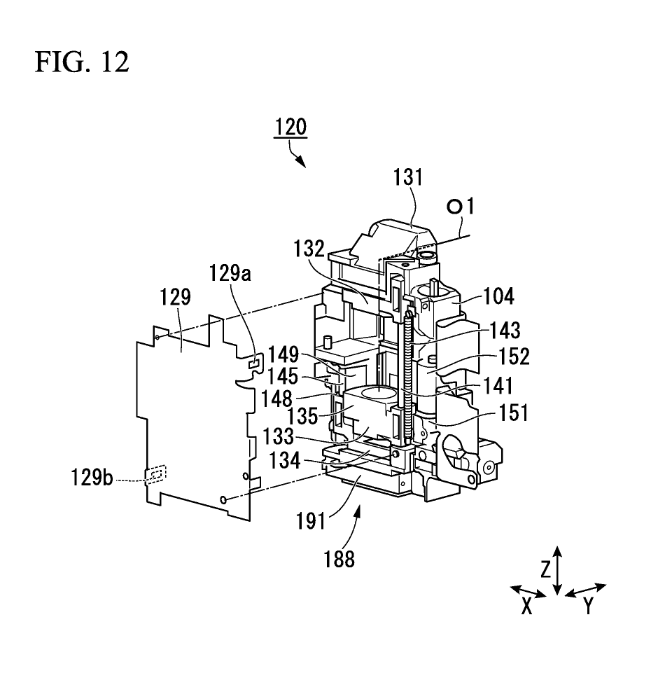

FIG. 12 is a schematic exploded perspective view showing the internal structure of the lens barrel of the second embodiment of the present invention.

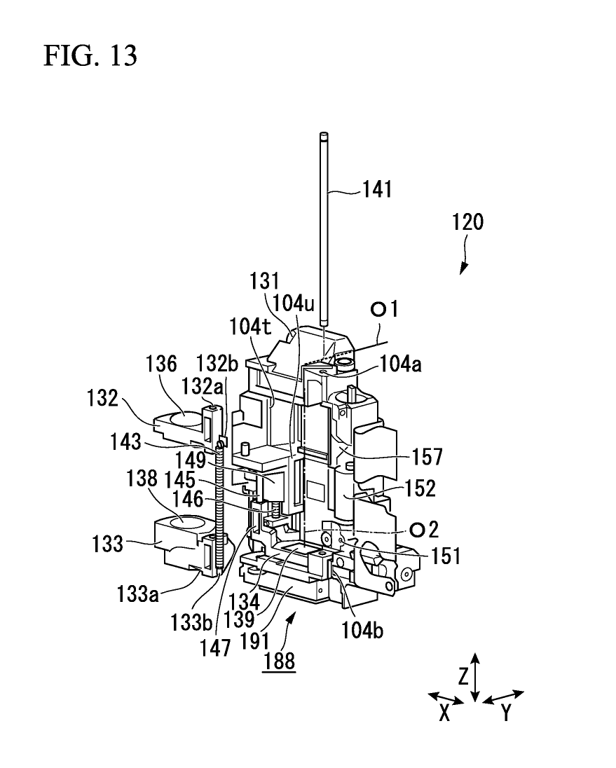

FIG. 13 is a schematic exploded perspective view around a second group frame and a third group frame of the lens barrel of the second embodiment of the present invention.

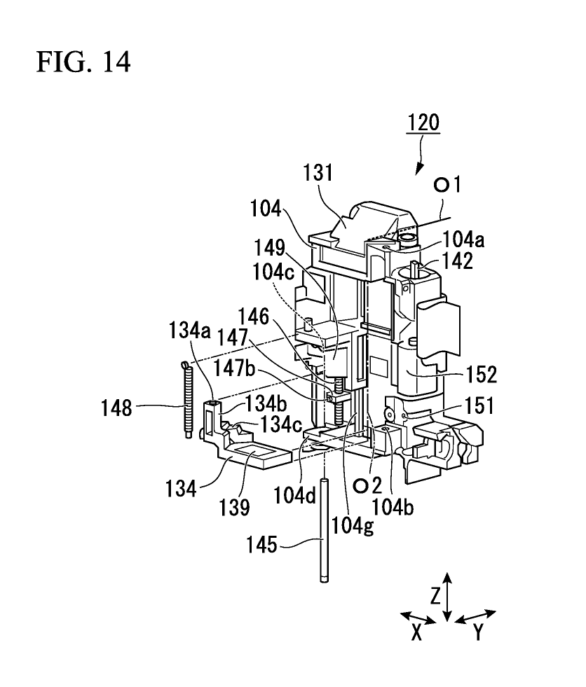

FIG. 14 is a schematic exploded perspective view around a fourth group frame of the lens barrel of the second embodiment of the present invention.

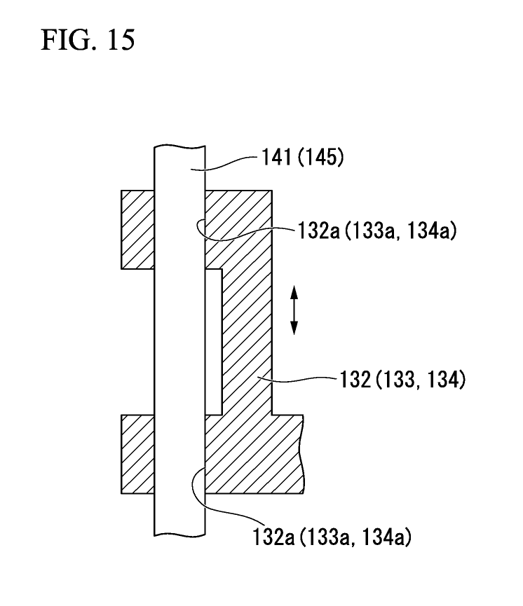

FIG. 15 is a schematic sectional view showing an example of a sliding portion of the lens barrel of the second embodiment of the present invention.

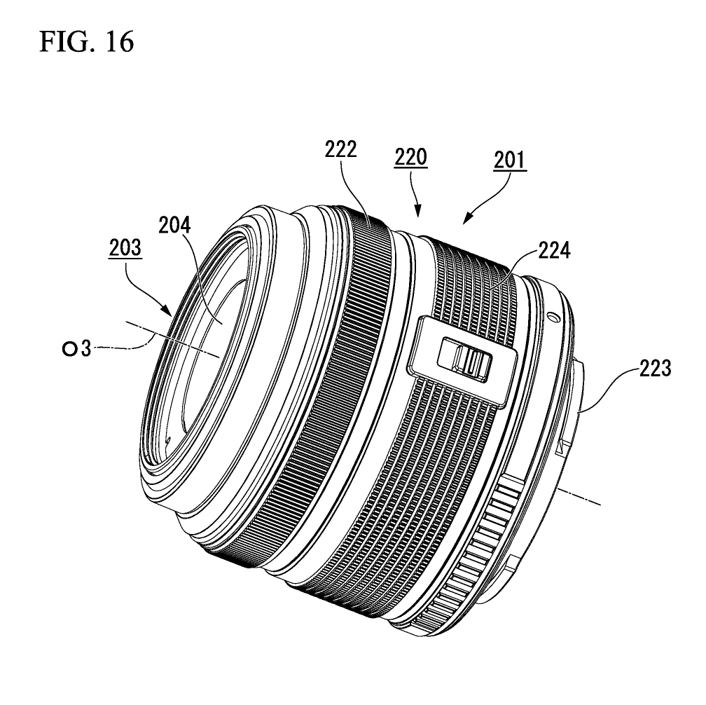

FIG. 16 is a schematic perspective view showing the external appearance of a lens barrel of a third embodiment of the present invention.

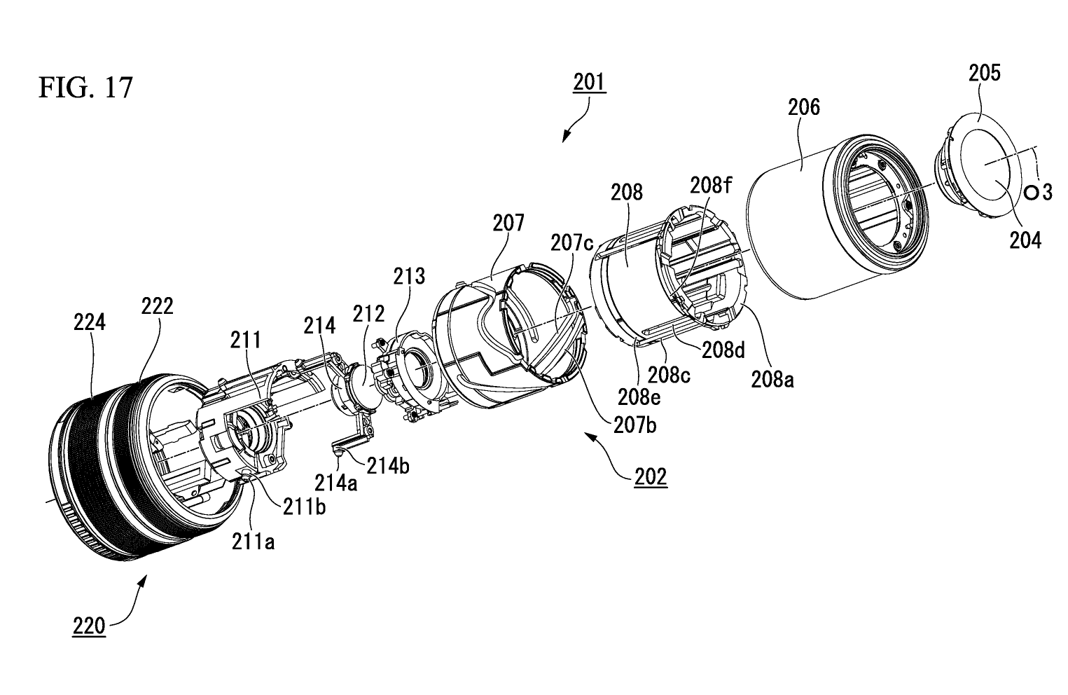

FIG. 17 is a schematic exploded perspective view of the lens barrel of the third embodiment of the present invention.

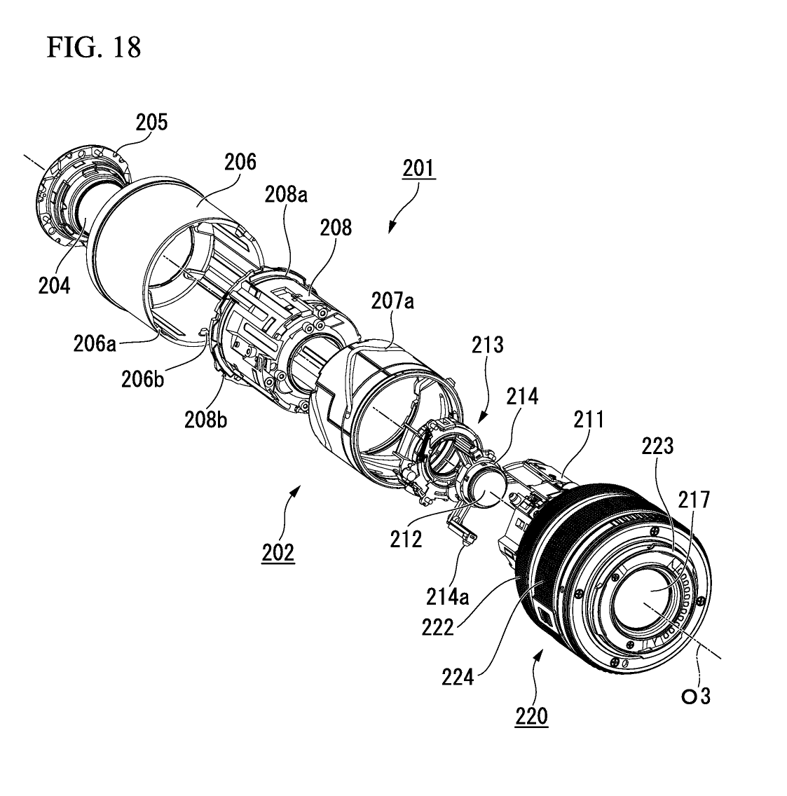

FIG. 18 is a schematic exploded perspective view of the lens barrel of the third embodiment of the present invention as viewed from another direction.

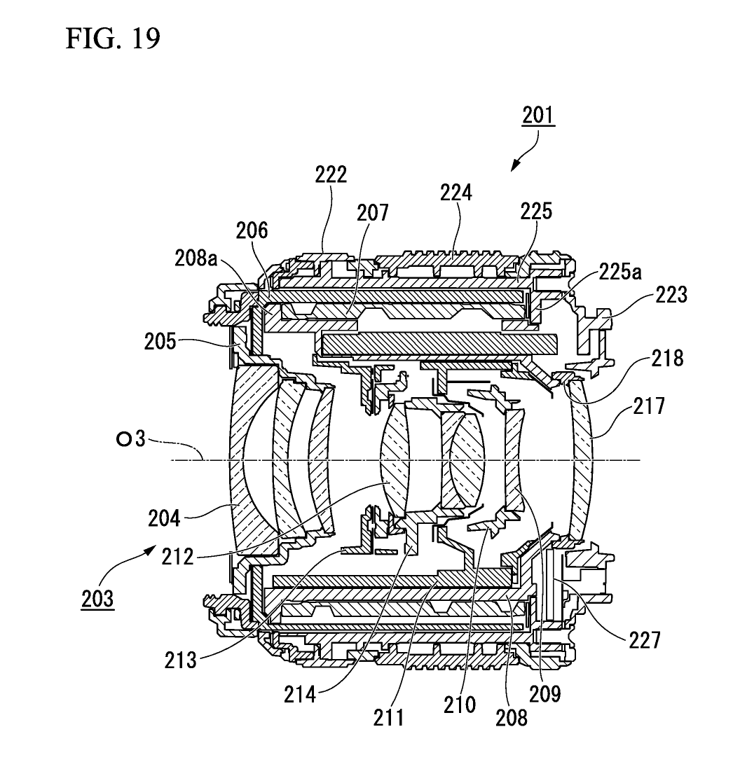

FIG. 19 is a schematic sectional view including an optical axis in a collapsed state of the lens barrel of the third embodiment of the present invention.

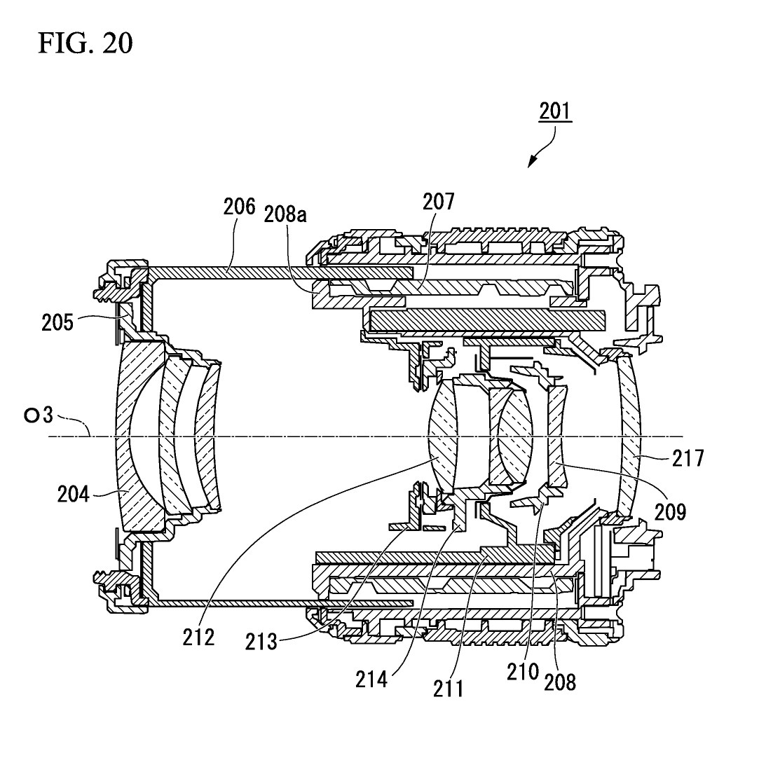

FIG. 20 is a schematic sectional view including the optical axis in a wide state of the lens barrel of the third embodiment of the present invention.

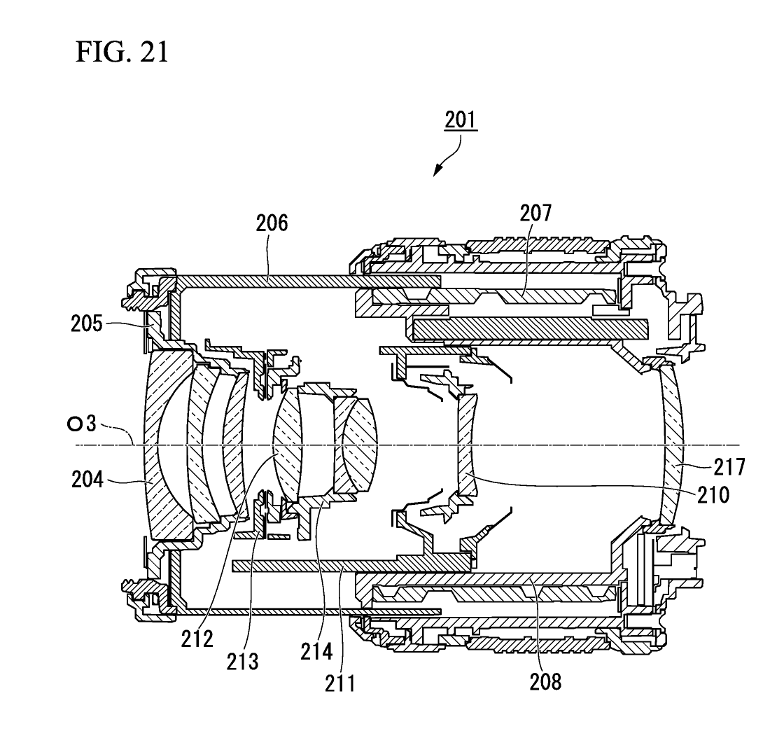

FIG. 21 is a schematic sectional view including the optical axis in a telephoto state of the lens barrel of the third embodiment of the present invention.

### DETAILED DESCRIPTION OF THE INVENTION

Hereinafter, embodiments of the present invention will be described with reference to the accompanying drawings. In all the drawings, even in the case of different embodiments, the same reference numerals will be given to the same or equivalent members, and common description will be omitted.

### First Embodiment

A lens barrel, an imaging device, and a part of the lens barrel in a first embodiment of the present invention will be described.

FIG. 1 is a schematic front view of the lens barrel of the first embodiment of the present invention. FIG. 2 is a sectional view taken along line A-A in FIG. 1. FIG. 3 is a schematic exploded perspective view showing a portion of the lens barrel of the first embodiment of the present invention. FIG. 4 is a schematic sectional view including an optical axis in a wide state of the lens barrel of the first embodiment of the present invention. FIG. 5 is a schematic sectional view including the optical axis in a telephoto state of the lens barrel of the first embodiment of the present invention. FIG. 6 is a schematic perspective view of a fixed frame of the lens barrel of the first embodiment of the present invention. FIG. 7A is a schematic sectional view of a sliding resin molding product that can be used for the lens barrel of the first embodiment of the present invention. FIG. 7B is an enlarged view of portion 13 in FIG. 7A.

As shown in FIGS. 1 to 3, a camera unit 1 that is an imaging device of the present embodiment can be built into a compact digital camera.

The camera unit 1 includes a lens barrel 2 that has an imaging optical system with a four-group optical system configuration, a zoom drive unit 50, a focus drive unit 60, and an imaging unit 90.

In the following descriptions, an optical axis of the imaging optical system in the lens barrel 2 is represented by symbol O.

In a direction (optical axis direction) along this optical axis O, a photographic subject side (object side) is referred to as “front”. Additionally, a direction in which respective movable frame members (to be described later) in the lens barrel 2 move to the front is referred to as an “extending direction”. Meanwhile, an imaging side (image side) in a direction along the optical axis O is referred to as “rear”, and a direction in which the respective movable frame members move to the rear is referred to as “a collapsing direction”.

Additionally, regions of the respective members in a direction along the optical axis O may be referred to as, for example, a “front end portion”, a “front side”, a “rear end portion”, a “rear side”, or the like in consistency with the names of “front” and “rear”.

A direction that is orthogonal to the optical axis O and is a lateral direction in FIG. 1 as viewed from the front is referred to as to an “X direction” that is a first direction, and particularly a rightward direction from the optical axis O is referred to as a “+X direction”. Similarly, a direction that is orthogonal to the optical axis O and is a longitudinal direction of FIG. 1 is referred to as to a “Y direction” that is a second direction, and particularly an upward direction from the optical axis O is referred to as a “+Y direction”. Additionally, a plane orthogonal to the optical axis O is referred to as an XY plane.

As shown in FIG. 2, the lens barrel 2 is brought into a collapsed state where the plurality of movable frame members have moved in the direction along the optical axis O, respectively, and the entire length of the lens barrel 2 is shortened, and the movable frame members are accommodated within a camera housing, for example, in an unused state (imaging-disabled state). Here, the unused state (imaging-disabled state) is a state where a power switch of a camera (not shown) mounted with the camera unit 1 is turned off, and the collapsed state is a form where the lens barrel 2 is not ready for imaging operation.

When the power switch of the camera (not shown) is turned on as shown in FIGS. 4 and 5, the lens barrel 2 is configured such that the respective movable frame members move forward in the direction along the optical axis O and the lens barrel 2 protrudes and extends forwardly from the front of the camera housing. Accordingly, the camera unit 1 including the lens barrel 2 is brought into a form where imaging operation can be performed, that is, an imaging standby state (imaging-enabled state) that is an operable state where the camera unit waits for the imaging operation.

Moreover, the lens barrel 2 is configured to have a telescopic mechanism that, in the imaging-enabled state, enables magnification operations (zooming) by advancing or retracting plurality of movable frame members between a short focal position (wide position) shown in FIG. 4 and a long focal position (telephoto position) shown in FIG. 5.

First, the configuration of the lens barrel 2 will be described.

As main constituent members are shown in the exploded perspective view of FIG. 3, the lens barrel 2 has a fixed frame 13, a rotary frame 11, a movable frame 10, a cam frame 5, a guide frame 8, a float key 9, a first group frame 4 (lens frame), a barrier unit 3, a second group frame 6 (lens frame), a third group frame 7 (lens frame), and a fourth group frame 12 (lens frame).

The fixed frame 13 has a cylindrical portion. The respective movable frame members are accommodated in an inner peripheral portion of the fixed frame 13, and an imaging unit 90 to be described later is secured to a rear surface portion of the fixed frame 13.

The fixed frame 13 is provided with a rotary frame cam groove 13a and a movable frame rectilinear guide groove 13c along a cylindrical inner peripheral surface 13e, the rotary cam groove 13a skews with respect to the direction along the optical axis O and the movable frame rectilinear guide groove 13c extends in the direction along the optical axis O.

Moreover, as shown in FIG. 6, the fixed frame 13 is provided with a fourth group frame rectilinear guide groove 13b that guides the movement of the fourth group frame 12 (to be described later) in the direction along the optical axis O, and a gear housing recess 13d in which a long gear 54 is accommodated.

The long gear 54 is a gear member that is accommodated in the gear housing recess 13d along a direction parallel to the optical axis O, and meshes with a gear portion 11a of the rotary frame 11 to be described later.

A zoom drive unit 50 for performing a zooming operation of the imaging optical system is arranged on the right side (the +X side in FIG. 1 and the left side of FIG. 6) of an outer peripheral portion of the cylindrical portion of the fixed frame 13.

As shown in FIG. 1, a focus drive unit 60 for performing a focusing operation of the imaging optical system is disposed at the part shown on the upper left of the outer peripheral portion of the cylindrical portion of the fixed frame 13.

As shown in FIG. 3, the rotary frame 11 is a substantially cylindrical movable frame member that is supported by the fixed frame 13 and rotationally driven during the zooming operation and the collapsing operation and that is driven forward and backward in the direction along the optical axis O. The rotary frame 11 is located on an inner peripheral side of the fixed frame 13 in a collapsed state (refer to FIG. 2).

An outer periphery of a rear end portion of the rotary frame 11 is fitted into the cylindrical inner peripheral surface 13e of the fixed frame 13 in a state where rotations and forward/backward movements are possible.

The outer periphery of the rear end portion of the rotary frame 11 is provided with a cam follower 11b that protrudes to an outer peripheral side. The cam follower 11b is slidably fitted into the rotary frame cam groove 13a of the fixed frame 13.

The gear portion 11a that meshes with the long gear 54 is provided in a predetermined range of the outer periphery of the rear end portion of the rotary frame 11.

A cam frame rectilinear groove 11d that guides the movement of the cam frame 5 in the direction along the optical axis O is provided at an inner peripheral portion of the rotary frame 11 so as to extend in the direction along the optical axis O.

By virtue of such a configuration, if the rotary frame 11 is rotationally driven by the rotation of the long gear 54, which is driven by the zoom drive unit 50, the rotary frame 11 is driven forward and backward in the direction along the optical axis O while rotating along the rotary frame cam groove 13a.

In addition, a decoration ring 33 is mounted on an outer peripheral portion of a front surface of the rotary frame 11.

The movable frame 10 is a substantially cylindrical rectilinear movable frame member that moves forward and backward together with the rotary frame 11 in a state where the movable frame 10 is inserted into and arranged in an inner peripheral side of the rotary frame 11 and the rotation thereof around the optical axis O is restricted with respect to the fixed frame 13 (hereinafter referred to as a “rotation-restricted state”).

The movable frame 10 is combined with the rotary frame 11 in a bayonet manner at a rear end portion thereof and thereby supported so as to be movable forward and backward integrally with the rotary frame 11 in the direction along the optical axis O and be relatively rotatable around the optical axis O with respect to the rotary frame 11.

A guide pin 10b is provided on an outer periphery of a rear end portion of the movable frame 10 so as to protrude therefrom. The guide pin 10b is engaged with the movable frame rectilinear guide groove 13c of the fixed frame 13.

Accordingly the movable frame 10 is movable forward and backward together with the rotary frame 11 in the rotation-restricted state.

A cam frame cam groove 10c that skews with respect to the optical axis O is provided in a cylindrical portion of the movable frame 10 so as to pass therethrough in a radial direction.

An inner peripheral surface 10e of the movable frame 10 is provided with a guide frame rectilinear guide groove 10g that guides the movement of the guide frame 8 (to be described later) in the direction along the optical axis O, and a float key rectilinear guide groove 10f that guides the movement of the float key 9 (to be described later) in the direction along the optical axis O.

The cam frame 5 is a substantially cylindrical movable frame member that rotates together with the rotary frame 11 and moves forward and backward in the direction along the optical axis O relative to the rotary frame 11.

The cam frame 5 is fitted into an inner peripheral portion of the movable frame 10, and is assembled so as to be rotatable around the optical axis O and movable forward and backward in the direction along the optical axis O.

An outer periphery of a rear end portion of the cam frame 5 is provided with a cam follower 38 that protrudes radially outward. A rectilinear guide pin protrudes radially outward from a central portion of the cam follower 38.

The cam follower 38 is slidably fitted into the cam frame cam groove 10c of the movable frame 10, and the rectilinear guide pin is slidably fitted into the cam frame rectilinear groove 11d of the rotary frame 11 after being inserted through the cam frame cam groove 10c.

Accordingly, the cam frame 5 is supported by the movable frame 10 so as to be movable forward and backward in the direction along the optical axis O along the cam frame cam groove 10c of the movable frame 10 while rotating together with the rotary frame 11.

An outer peripheral surface 5d of the cylindrical portion of the cam frame 5 is provided with three pairs of first group frame cam grooves 5a that have the same cam curve (cam groove centroid).

An inner peripheral surface 5f of the cylindrical portion of the cam frame 5 is provided with three second group frame cam grooves 5c and three third group frame cam grooves 5e.

Cam followers 36 of the first group frame 4 to be described later are respectively fitted into the first group frame cam grooves 5a. Accordingly, the first group frame cam grooves 5a function as cam grooves for forward and backward driving of the first group frame 4.

Cam followers 39 of the second group frame 6 to be described later are fitted into the second group frame cam grooves 5c. Accordingly, the second group frame cam grooves 5c function as cam grooves for forward and backward driving of the second group frame 6.

Cam followers 41 of the third group frame 7 to be described later are fitted into the third group frame cam grooves 5e. Accordingly, the third group frame cam grooves 5e function as cam grooves for forward and backward driving of the third group frame 7.

The guide frame 8 is a substantially cylindrical rectilinear movable frame member. A rear end portion of the guide frame 8 is combined with the cam frame 5 in a bayonet manner. Accordingly, the guide frame 8 moves forward and backward together with the cam frame 5 in the direction along the optical axis O, and is supported by the cam frame 5 in a state where the guide frame 8 is relatively rotatable around the optical axis O.

An outer periphery of the rear end portion of the guide frame 8 is provided with a guide projection 8a that protrudes radially outward.

The guide projection 8a is slidably fitted into the guide frame rectilinear guide groove 10g of the movable frame 10. Accordingly, the guide frame 8 is supported on the inner side of the movable frame 10 in a state where the rotation thereof is restricted by the movable frame 10 and in a state where the guide frame is movable forward and backward in the direction along the optical axis O together with the cam frame 5.

An inner peripheral surface 8e of a cylindrical portion of the guide frame 8 is provided with a first group frame rectilinear guide groove 8b that guides the movement of the first group frame 4 (to be described later) in the direction along the optical axis O.

The float key 9 is a substantially cylindrical rectilinear movable frame member that moves forward and backward in the direction along the optical axis O together with the cam frame 5 in the rotation-restricted state. That is, the float key 9 is a rectilinear guide frame that restricts the movement of the second group frame 6 and the third group frame 7 in a rotational direction and guides the rectilinear movement thereof in the direction along the optical axis O such that the second group frame 6 and the third group frame 7 do not rotate about the optical axis O.

A rear end portion of the float key 9 is combined with the cam frame 5 in a bayonet manner. Accordingly, the float key 9 moves forward and backward together with the cam frame 5 in the direction along the optical axis O, and is supported by the cam frame 5 in a state where the flat key 9 is rotatable relative to the cam frame 5 around the optical axis O.

An outer periphery of the rear end portion of the float key 9 is provided with a guide projection 9a that protrudes radially outward.

The guide projection 9a is slidably fitted into the float key rectilinear guide groove 10f of the movable frame 10. Accordingly, the float key 9 is supported by the movable frame 10 in a state where the rotation thereof is restricted by the movable frame 10 and in a state where the float key 9 is movable forward and backward in the direction along the optical axis O together with the cam frame 5.

A second group frame rectilinear guide groove 9c and a third group frame rectilinear guide groove 9d are respectively provided in the cylindrical portion of the float key 9 so as to pass therethrough in the radial direction.

The second group frame rectilinear guide groove 9c is a guide portion that extends in the direction along the optical axis O and guides the rectilinear movement of the second group frame 6.

The third group frame rectilinear guide groove 9d is a guide portion that extends in the direction along the optical axis O and guides the rectilinear movement of the third group frame 7.

The first group frame 4 is a substantially cylindrical movable frame member that holds a first group lens 21 (a lens or an optical member) that moves forward and backward in the direction along the optical axis O in the rotation-restricted state through the rotation of the cam frame 5.

As shown in FIG. 2, a lens holding portion 4b that holds the first group lens 21 is provided on an inner peripheral side of a tip portion of the first group frame 4.

Additionally, as shown in FIG. 3, three pairs of cam followers 36 that are respectively and slidably fitted into the three pairs of first group frame cam grooves 5a of the cam frame 5 are secured to a radial inner side of a rear end portion of the first group frame 4. Additionally, an outer peripheral portion of the first group frame 4 is provided with a guide protrusion 4a that is slidably fitted into the first group frame rectilinear guide groove 8b of the guide frame 8.

For this configuration, the first group frame 4 is movable forward and backward with the rotation by the forward/backward movement of the cam frame 5, in a state where the rotation thereof is restricted by the guide frame 8.

The barrier unit 3 is a device portion that protects the first group lens 21 held by the first group frame 4 and opens to let a front surface of the first group lens 21 appear when being used.

The barrier unit 3 has four barrier vanes 3a built thereinto, and is mounted on a front surface portion of the first group frame 4.

The barrier unit 3 retracts the barrier vanes 3a with the advancing operation of the first group frame 4 from the collapsed position, and brings the front surface of the first group lens 21 into appearance. Additionally, the barrier unit 3 moves the barrier vanes 3a to a closed position with the retracting of the first group frame 4 from an imaging position, and brings the front surface of the first group lens 21 into a hidden state.

The second group frame 6 is a substantially cylindrical movable frame member that holds a second group lens 22 (a lens or an optical member) that moves forward and backward in the direction along the optical axis O in the rotation-restricted state through the rotation of the cam frame 5.

As shown in FIG. 2, a lens holding portion 6b that holds the second group lens 22 is provided on an inner side of the second group frame 6.

As shown in FIG. 3, an outer peripheral portion of the second group frame 6 is provided with three guide protrusions 6a and the cam followers 39, the cam followers 39 are secured to the guide protrusions 6a in the state of protruding radially outward from the centers of the respective guide protrusions 6a.

The guide protrusions 6a are arranged so as to be separated in the circumferential direction, protrude radially outward, and are slidably fitted into the second group frame rectilinear guide groove 9c of the float key 9.

Accordingly, the cam followers 39 are slidably fitted into the second group frame cam grooves 5c of the cam frame 5 arranged on an outer peripheral side of the float key 9.

For this configuration, the second group frame 6 is movable forward and backward with the rotation and forward/backward movement of the cam frame 5 in a state where the rotation thereof is restricted by the second group frame rectilinear guide groove 9c of the float key 9.

The second group frame 6 is assembled into a rear side of the first group frame 4 in a state where the second group frame is fitted into an inner peripheral portion of the float key 9 so as to be movable forward and backward in the rotation-restricted state in this way (refer to FIG. 2).

The third group frame 7 is a substantially cylindrical movable frame member that holds a third group lens 23 (a lens or an optical member) that moves forward and backward in the direction along the optical axis O in the rotation-restricted state through the rotation of the rotary frame 11.

As shown in FIG. 2, a lens holding portion 7b that holds the third group lens 23 is provided on an inner side of the third group frame 7.

As shown in FIG. 3, an outer peripheral portion of the third group frame 7 is provided with three guide protrusions 7a, and the cam followers 41 secured to the guide protrusions 7a in a state of protruding radially outward from the centers of the respective guide protrusions 7a.

The guide protrusions 7a are arranged at a front end portion of the third group frame 7 so as to be separated in the circumferential direction, protrude radially outward, and are slidably fitted into the third group frame rectilinear guide groove 9d of the float key 9.

Accordingly, the cam followers 41 are slidably fitted into the third group frame cam grooves 5e of the cam frame 5 arranged on the outer peripheral side of the float key 9.

For this configuration, the third group frame 7 is movable forward and backward with the rotation and forward/backward movement of the cam frame 5 in a state where the rotation thereof is restricted by the third group frame rectilinear guide groove 9d of the float key 9.

The third group frame 7 is assembled into a rear side of the second group frame 6 in the rotation-restricted state, and the third group frame 7 is fitted into the inner peripheral portion of the float key 9 so as to be movable forward and backward in this way.

Additionally, a shutter/diaphragm control unit (not shown) is mounted to a rear surface side of the third group frame 7.

The fourth group frame 12 is a substantially cylindrical movable frame member that is supported by the fixed frame 13 so as to be movable forward and backward in the direction along the optical axis O and holds a fourth group lens 24 (a lens or an optical member).

As shown in FIG. 2, a lens holding portion 12b that holds the fourth group lens 24 is provided on an inner side of the fourth group frame 12.

As shown in FIG. 3, an outer peripheral portion of the fourth group frame 12 is provided with two arms 12c that extend radially outward.

One arm 12c is provided with a guide protrusion 12a.

The other arm 12c is provided with a guide shaft hole into which a guide shaft 65, constituting a portion of the focus drive unit 60 (to be described later) supported by the fixed frame 13, is slidably fitted, and an engaging portion that is engaged with a nut 64 constituting a portion of the focus drive unit 60 (to be described later).

The guide protrusion 12a is slidably fitted into the fourth group frame rectilinear guide groove 13b of the fixed frame 13.

For this configuration, the fourth group frame 12 is supported so as to be movable forward and backward in the direction along the optical axis O, in the rotation-restricted state where the fourth group frame is guided by the guide shaft 65 and the fourth group frame rectilinear guide groove 13b.

The fourth group frame 12 is arranged between the shutter/diaphragm control unit (not shown) and the imaging unit 90.

As shown in FIG. 6, the zoom drive unit 50 is disposed at a cylindrical outer peripheral portion of the fixed frame 13, and includes a zoom motor 51 consisting of a DC motor, a gear box 52 that has a reduction gear train built thereinto, and the long gear 54.

In the zoom drive unit 50, if the zoom motor 51 is rotationally driven during the collapsing driving and zoom driving of the lens barrel 2, the rotary frame 11 is rotationally driven via the long gear 54, and the extending and collapsing of the lens barrel 2 are performed.

As shown in FIGS. 1 and 3, the focus drive unit 60 is arranged on an outer peripheral side of the cylindrical portion of the fixed frame 13, and as shown in FIG. 3, includes a focal motor 61, the guide shaft 65, a feed screw 66, the nut 64, and a fourth group frame biasing spring 67.

The focal motor 61 is a motor that generates the driving power that moves the fourth group frame 12 forward and backward, and is supported by the fixed frame 13. The focal motor 61 of the present embodiment consists of a stepping motor.

The guide shaft 65 is disposed along the direction parallel to the optical axis O and is slidably fitted into the guide shaft hole of the fourth group frame 12, and a shaft end portion thereof is supported by the fixed frame 13.

The focal motor 61 is connected to an end portion of the feed screw 66, and the feed screw 66 is rotationally driven by the focal motor 61.

The nut 64 engaged with the engaging portion of the other arm 12c of the fourth group frame 12 is engaged with the feed screw 66.

The fourth group frame biasing spring 67 consists of an extension spring, and is suspended between the fixed frame 13 and the fourth group frame 12, and the fourth group frame 12 is made to abut against the nut 64 by biasing the fourth group frame 12.

According to the focus drive unit 60 having such a configuration, if the focal motor 61 is rotationally driven during the focusing driving of the lens barrel 2, the feed screw 66 is rotationally driven and the nut 64 moves forward and backward.

Accordingly, the fourth group frame 12 engaged with the nut 64 moves forward and backward in the direction along the optical axis O together with the nut 64.

Next, the first group lens 21, the second group lens 22, the third group lens 23, and the fourth group lens 24 that constitute the imaging optical system of the lens barrel 2 will be simply described.

The first group lens 21 is a lens group that consists of a positive cemented lens and a positive meniscus lens in this order from the photographic subject side and moves toward the photographic subject side in varying from a wide end to a telephoto end. The second group lens 22 consists of three components of a negative meniscus lens, a biconcave lens, and a biconvex lens in this order from the photographic subject side, and moves toward an image surface side while the distance to the first group lens 21 is widened and the distance to the third group lens 23 is narrowed in varying from the wide end to the telephoto end. The second group lens 22 is more shifted toward the photographic subject side at the telephoto end than at the wide end.

The third group lens 23 consists of a biconvex lens and a negative meniscus lens in this order the photographic subject side, moves toward the photographic subject side while the distance to the second group lens 22 is narrowed in varying from the wide end to an intermediate state, and moves toward the photographic subject side while the distance to the second group lens 22 is narrowed in varying from the intermediate state to the telephoto end. The third group lens 23 is shifted toward the photographic subject side at the telephoto end than at the wide end.

The fourth group lens 24 consists of one biconvex lens having a larger aperture than the third group lens 23. The fourth group lens 24 is driven forward and backward during focusing.

The imaging unit 90 is a holding member that includes an imaging element 96 (optical member) that photoelectrically converts an image formed by the imaging optical system held by the lens barrel 2. The imaging unit 90 places the imaging element 96 on the image surface of the imaging optical system.

In the present embodiment, the imaging unit 90 supports the imaging element 96 so as to be movable within an XY plane, and it is possible to correct camera shake on the basis of a camera shake detection signal detected on a camera side during imaging.

In the camera unit 1 having such a configuration, when the camera unit is assembled into a camera and used, the camera unit is set to the wide state shown in FIG. 4, the telephoto state shown in FIG. 5, and the intermediate state between these states, through the extending operation from the collapsed state shown in FIG. 2 by turning on a power switch of the camera.

In detail, under the control of the camera control unit, the zoom motor 51 is driven, and the rotary frame 11 is rotated and driven for extending. With the rotation and moving of the rotary frame 11, first, the barrier unit 3 is brought into the open state, and the first group frame 4, the second group frame 6, and the third group frame 7 move to their respective zoom positions. Additionally, the focal motor 61 is driven on the basis of a distance measurement signal, the fourth group frame 12 is moved to its focal position, and the shutter/diaphragm control unit (not shown) is controlled on the basis of an exposure signal and brought into a state where the camera unit 1 can perform imaging.

When the lens barrel 2 is collapsed to the collapsed state from such a state where imaging is possible, the respective movable frame members are retracted to the fixed frame 13 side and brought into the collapsed state by driving the zoom motor 51 and the focal motor 61. In this collapsed state, the respective movable frame members are brought into contact with each other in the direction along the optical axis O or are brought into a state that is very close to contact, and the first group lens 21, the second group lens 22, the third group lens 23, and the fourth group lens 24 are also arranged in series in a state that is close to contact. Particularly, the first group frame 4, the second group frame 6, and the third group frame 7 are collapsed into a state where the frames are brought into substantially contacted state with each other.

Thus, in the lens barrel 2, the first group lens 21, the second group lens 22, the third group lens 23, and the fourth group lens 24 as optical members, are moved in the direction along the optical axis O. Among the respectable movable frame members, members engaging with other members, the fixed frame 13, and the rotary frame 11 engaged with the fixed frame 13 slide against each other in a contact portion or an engaging portion therebetween with the movement of the optical members. Additionally, the members, which are adjacent to each other in the radial direction in the collapsed state, may slide against each other while at least portions of an outer peripheral surface and an inner peripheral surface of the respective members abut against each other.

In related-art lens barrels having a similar mechanism, sliding friction is reduced by coating such a sliding portion with grease serving as lubricant in order to reduce necessitated driving power.

In the present embodiment, at least part of the grease coating can be omitted by using at least one of the members that slide against each other is made as a first part: the first part is molded with a resin material in which additive with a friction-reducing property is added to base resin to make the additive exposed on the surface of the first part, thus the first part has a less friction with another contacting member compared with the case in which such an additive is not added.

For this reason, the material itself of the first part is sliding resin so the surface of the first part is not coated. That is, the first part is not a part of which the slidability is improved by performing coating on the surface thereof.

A second part that slides relative to such a first part is configured to come into contact with and slide against the first part in a sliding portion without a coating substance, such as grease, being interposed therebetween.

However, coating that does not aim to reduce friction may be applied on surface of a portion of the first part that does not slide against other parts.

Next, the sliding resin that is a resin material suitable for molding the first part will be described.

A sliding resin molding product 70 obtained by using the sliding resin of the present embodiment is shown in FIG. 7A.

The sliding resin molding product 70, as shown in FIG. 7B, is made of sliding resin containing a base resin 71 and an additive 72 that is added to the base resin 71 for reducing a friction.

The additive 72 is dispersed in the base resin 71, and at least a portion thereof is exposed on the base resin surface 71a of the base resin 71.

Since FIG. 7B is a schematic view, the additive 72 is drawn in a spherical shape. However, the shape of the additive 72 is not limited to a spherical shape, and suitable shapes other than the spherical shape are possible.

Additionally, the additive 72 is limited to neither solids nor particles, and for example, liquids, such as oil, are also possible.

The base resin 71 may be thermoplastic resin or may be thermosetting resin. Examples of resin suitable for the base resin 71 may include plant-derived resin, resin having carbon dioxide as a raw material, ABS resin, alkylene resins, such as polyethylene and polypropylene, styrene resin, vinyl resin, acrylic resin, amide resin, acetal resin, carbonate resin, urethane resin, epoxy resin, imide resin, urea resin, silicone resin, phenol resin, melamine resin, ester resin, amide resin, fluororesin, styrol resin, engineering plastic, and the like.

The engineering plastic can include polyamide resin, polybutylene terephthalate, polycarbonate resin, polyacetal resin, modified polyphenylene oxide resin, modified polyphenylene ether resin, polyphenylene sulfide resin, polyetheretherketone resin, polyether sulfone resin, polysulfone resin, polyamide imide resin, polyetherimide resin, polyimide resin, polyarylate resin, and polyallyl ether nitrile resin.

Two or more kinds of the resins shown above may be mixed together for the base resin 71. Since polycarbonate resin and polyamide resin among these resins have strong shock strength, these resins are particularly suitable as the base resin 71 used for the lens barrel 2.

For this reason, it is more preferable to contain at least one of polycarbonate and polyamide in the base resin 71.

As polycarbonate resin used for the base resin 71, normal one can be used. For example, aromatic polycarbonates manufactured by the reaction between an aromatic dihydroxy compound and a carbonate precursor can be preferably used.

Examples of the aromatic dihydroxy compound include, for example, 2,2-bis(4-hydroxyphenyl)propane (“bisphenol A”), bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cycloalkanes, bis(4-hydroxyphenyl) sulfide, bis(4-hydroxyphenyl) sulfone, bis(4-hydroxyphenyl) sulfoxide, bis(4-hydroxyphenyl) ether, and bis(4-hydroxyphenyl) ketone.

Examples of the carbonate precursor include carbonyl halides, carbonyl esters, and haloformates. Specifically, examples of the carbonate precursor include phosgene, dihaloformates of dihydric phenol, diphenyl carbonate, dimethyl carbonate, diethyl carbonate, and the like.

Additionally, the polycarbonate resin used for the base resin 71 may be a polycarbonate resin that does not contain aromatic constituents. As the polycarbonate resin that does not contain aromatic constituents, alicyclic polycarbonates, aliphatic polycarbonates, or the like can be exemplified.

The polycarbonate resin may be straight-chain or may be branched-chain. Additionally, the polycarbonate resin may be copolymers of a polymer, which is obtained by polymerizing an aromatic dihydroxy compound and a carbonate precursor, and other polymer.

The above-described polycarbonate resin can be manufactured by well-known methods in the related art. The well-known methods include, for example, various methods, such as an interfacial-polymerization method, a melt transesterification method, and a pyridine method.

As the additive 72, an organosilicon compound, a fluorine compound, molybdenum disulfide, an organic molybdenum compound, graphite fluoride, graphite, or the like can be exemplified.

As the additive 72, only one kind of these materials may be added, or two or more kinds of these materials may be mixed together and added.

Since the organosilicon compound and the fluorine compound among the additives exemplified above have a high slidability-improving effect, these compounds are particularly suitable. For this reason, it is more preferable that at least one of an organosilicon compound and a fluorine compound is contained in the sliding resin molding product 70 as the additive 72.

The content of the additive 72 is preferably 0.1 wt % to 20 wt %, and is more preferably 0.1 wt % to 10 wt %.

When the content of the additive 72 is less than 0.1 wt %, the amount of the additive 72 exposed on the base resin 71 is too small, and the friction properties of the surface of the sliding resin molding product 70 are not greatly different from the friction properties of the base resin 71. For this reason, the slidability-improving effect becomes low.

When the content of the additive 72 is more than 20 wt %, the amount of the additive 72 is too large and the moldability and mechanical strength of the sliding resin molding product 70 degrade often.

It is preferable that the kind and content of the additive 72 are determined such that the coefficient of dynamic friction for the sliding resin molding product 70 becomes as low as possible within a range where rigidity and strength required for the sliding resin molding product 70 are obtained.

In order to obtain rigidity that is preferable for a constituent member of the lens barrel 2, it is preferable that, for example, the bending elastic modulus of the sliding resin molding product 70 is equal to or higher than 6 GPa.

In order to obtain preferable sliding properties for the lens barrel 2 without grease, for example, it is preferable that the coefficient of dynamic friction under a load of 20 g is equal to or lower than 0.2, and additionally it is more preferable that the coefficient of dynamic friction under the same condition is equal to or lower than 0.1.

In the sliding resin molding product 70, in addition to the additive 72, other additives that do not aim to reduce friction, for example, additives, such as a filler, a flame retardant promoter, a flame retarder, an antioxidant, a mold-releasing agent, a colorant, and a dispersant can be added.

The filler includes, for example, carbon fibers, glass fibers, cellulose fibers, clay, titanium oxide, silica, talc, calcium carbonate, potassium titanate, mica, montmorillonite, barium sulfate, a balloon filler, a bead filler, a carbon nanotube, or the like.

A halogen-based flame retarder, a nitrogen-based flame retarder, a metal hydroxide, a phosphorus-based flame retarder, an organic alkali metal salt, an organic alkaline earth metal salt, a silicone-based flame retarder, expandable graphite, or the like can be used as the flame retarder.

A polyfluoroolefin, antimony oxide, or the like can be used as the flame retardant promoter.

A phosphorus-based antioxidant, a phenolic antioxidant, or the like can be used as the antioxidant.

The mold-releasing agent includes higher alcohols, carboxylate esters, polyolefin waxes, and polyalkylene glycols.

Arbitrary colorants, such as carbon black and phthalocyanine blue, can be used as the colorant.

An anionic surfactant, a cationic surfactant, a nonionic surfactant, and an ampholytic surfactant, a polymeric dispersant, and combinations thereof can be exemplified as the dispersant.

All of the parts of the lens barrel used for the lens barrel 2, for example, the fixed frame 13, the rotary frame 11, the movable frame 10, the cam frame 5, the guide frame 8, the float key 9, the first group frame 4, the second group frame 6, the third group frame 7, the fourth group frame 12, and the like may be the first part formed as the sliding resin molding product 70 described above.

Additionally, the second part corresponds to all parts that come into contact with the first part and slide relative thereto with the movement of the optical members. In this case, the second part may be a resin part different from the sliding resin molding product 70, or may be parts other than resin, for example, metal parts.

Additionally, since friction is further reduced if the sliding resin molding product 70 is also use for the second part, this is more preferable. For example, when required strength is secured even in members for which metal is used in the related art, it is possible to use the sliding resin molding product 70.

In this case, it is not indispensable that the sliding resin molding product 70 constituting the first part and the sliding resin molding product 70 constituting the second part having the same compositional proportions. That is, when both of the first part and the second part are made of the sliding resin molding product 70, it is possible to change the kind of the base resin 71 and the kind of the additive 72. Additionally, it is also possible to adopt mutually different numerical values for the contents of the additives 72.

In the following, members that are particularly preferably formed as the sliding resin molding product 70 will be described.

It is preferable that the float key 9 is formed as the sliding resin molding product 70. In this case, the frictional coefficient of the surface of the float key 9 decreases, so that the sliding load between the float key 9 and another member that comes into contact with the float key 9 and slides relative thereto can be reduced.

Specifically, the sliding resistance between the float key 9 (first part), and the second and third group frames 6 and 7 (second part) can be reduced. Accordingly, the lubricant (grease) with which coating is applied in the related art becomes unnecessary between the float key 9 and the second and third group frames 6 and 7.

Although the second group lens 22 and the third group lens 23 that are optical members, respectively, are held by the second group frame 6 and the third group frame 7 on the inner peripheral side of the float key 9, there is no case where the grease volatilizes and lens surfaces become cloudy because the float key 9 and the second and third group frames 6 and 7 come into contact with each other without the grease. For this reason, degradation of imaging performance can be prevented.

It is preferable that the cam frame 5 is formed as the sliding resin molding product 70.

In this case, the frictional coefficient of the surface of the cam frame 5 decreases, so that the sliding load between the cam frame 5 and another member that comes into contact with the cam frame 5 and slides relative thereto can be reduced.

Specifically, the sliding resistance between the cam frame 5 (first part), and the first, second, and third group frames 4, 6, and 7 (second part) can be reduced. Accordingly, the lubricant (grease) with which coating is applied in the related art becomes unnecessary between the cam frame 5 and the first, second and third group frames 4, 6 and 7.

Although the first group lens 21, the second group lens 22, and the third group lens 23 that are optical members, respectively, are held by the first group frame 4, the second group frame 6, and the third group frame 7 on of the inner peripheral side of the cam frame 5, there is no case where the grease volatilizes and the lens surfaces become cloudy because the cam frame 5 and the first, second, and third group frames 4, 6 and 7 come into contact with each other without the grease. For this reason, degradation of imaging performance can be prevented.

It is preferable that the fourth group frame 12 is formed as the sliding resin molding product 70.

In this case, the frictional coefficient of the surface of the fourth group frame 12 decreases, so that the sliding load between the fourth group frame 12 and another member that comes into contact with the fourth group frame 12 and slide relative thereto can be reduced.

Specifically, the sliding resistance between the fourth group frame 12 (first part), and the guide shaft 65 (second part) and the fourth group frame rectilinear guide groove 13b that is a guide portion in the fixed frame 13 (second part) can be reduced. Accordingly, the lubricant (grease) with which coating is applied in the related art becomes unnecessary between the fourth group frame 12, and the guide shaft 65 and the guide portion of the fixed frame 13.

Although the fourth group frame 12 holds the fourth group lens 24 and is also close to the imaging element 96 that is an optical member, there is no case where the grease volatilizes and the lens surfaces and the imaging surface of the imaging element 96 become cloudy because the fourth group frame 12, and the guide shaft 65 and the fixed frame 13 come into contact with each other without the grease. For this reason, degradation of imaging performance can be prevented.

Here, the strength of the lens barrel 2 of the present embodiment will be described.

When the lens barrel 2 is in a photography-enabled state, and for example, when the camera is dropped, a shocking load may be applied and the lens barrel may be damaged.

The load applied to the first group frame 4 is transmitted to the first group frame cam grooves 5a of the cam frame 5 via the cam followers 36. Additionally, the load is transmitted to the cam frame cam groove 10c of the movable frame 10 via the cam follower 38 of the cam frame 5.

Since the movable frame 10 and the rotary frame 11 are combined together in a bayonet manner, the load applied to the movable frame 10 is transmitted to the rotary frame 11 via a bayonet. The load applied to the rotary frame 11 is finally transmitted to the fixed frame 13 via the cam follower 11b.

Damage occurs from a portion with weak strength in the process of such load transmission.

That is, sliding resin with high strength and rigidity are required for the first group frame 4, the cam frame 5, the movable frame 10, the rotary frame 11, and the fixed frame 13.

For this reason, for example, it is possible to use the sliding resin containing polyamide for the first group frame 4, the cam frame 5, the movable frame 10, the rotary frame 11, and the fixed frame 13, thereby reducing the sliding resistance without impairing strength.

By using the sliding resin containing polyamide, the lubricant (grease) that has been used in the related art becomes unnecessary.

In this way, in the present embodiment, the lens barrel 2 is configured such that the first part molded from a resin material to which the additive 72 that reduces friction is added, and the second part come into surface contact with each other and slide relative each other. For this reason, a driving load can be reduced by virtue of a simple configuration.

Additionally, since such low sliding resistance is obtained without performing coating with grease between the first part and the second part, volatilization of the grease within the lens barrel 2 can be prevented. For this reason, clouding of the optical members in the lens barrel 2 and the camera unit 1 can be prevented.

Additionally, even when grease is used for some sliding portions, the amount of volatilization of the grease can be reduced compared to a case where the grease is used for all sliding portions. In this case, particularly excellent effects are obtained, particularly, by using the sliding resin molding product 70 for the movable frame members near the optical members.

When at least a portion of a sliding surface is exposed to an optical member during the sliding between the first part and the second part, grease, which has volatilized if the exposed portion is coated with the grease, tends to adhere to the optical member and cause clouding. To avoid such a case, the greaseless state is particularly effective. For example, in an optical lens barrel, it is preferable that all or some of sliding surfaces exposed to an optical member are made “greaseless” even if the rest of sliding surfaces are still “greased,” because the optical lens barrel can enjoy both of easy-smoothness of “greased” surfaces and suppressed optical clouding thanks to “grease-less” surfaces. Particularly, an optical lens barrel, in which all surfaces of which at least portions are exposed to optical members are made greaseless, is particularly preferable because the effect of suppressing occurrence of clouding is high.

Additionally, in order to avoid exfoliation of the additive exposed to an upper surface of the base resin caused by friction and shock from the outside, parts to which the additive are added are preferably located inside the lens barrel and are not exposed to the outside.

### Second Embodiment

A lens barrel, an imaging device, and a part of the lens barrel in a second embodiment of the present invention will be described.

FIG. 8 is a schematic perspective view showing an external appearance as viewed from a front surface side of an imaging device of a second embodiment of the present invention. FIG. 9 is a schematic perspective view showing an external appearance as viewed from a rear surface side of the imaging device of the second embodiment of the present invention. FIG. 10 is a schematic perspective view showing an internal arrangement on the rear surface side of the imaging device of the second embodiment of the present invention. FIG. 11 is a schematic sectional view, including an optical axis, of a lens barrel of the second embodiment of the present invention. FIG. 12 is a schematic exploded perspective view showing the internal structure of the lens barrel of the second embodiment of the present invention. FIG. 13 is a schematic exploded perspective view around a second group frame and a third group frame of the lens barrel of the second embodiment of the present invention. FIG. 14 is a schematic exploded perspective view around a fourth group frame of the lens barrel of the second embodiment of the present invention. FIG. 15 is a schematic sectional view showing an example of a sliding portion of the lens barrel of the second embodiment of the present invention.

As shown in FIGS. 8 to 10, a digital camera 101 that is an imaging device of the present embodiment is a compact type digital camera.

The digital camera 101 has a barrel frame unit 120 (refer to FIG. 10) having a bending optical system for imaging a photographic subject built thereinto as a lens barrel, and includes a camera shake correcting device that moves an imaging element as an imaging means according to camera shake.

The above bending optical system is an imaging optical system configured so as to bend a photographic subject beam, which has entered along a first optical axis (hereinafter referred to as an optical axis O1), in a second optical axis direction (hereinafter referred to as an optical axis O2) that is an optical axis of the imaging optical system orthogonal to the optical axis O1 and so as to form an optical image on a light receiving surface of the imaging element arranged on the optical axis O2.

Additionally, a shock-absorbing structure that protects the barrel frame unit 120 from shock at falling or the like, is applied to the digital camera 101.

In the following description, a photographic subject side in the direction of the optical axis O1 in the digital camera 101 is referred to as a “front side”. Additionally, a direction parallel to the optical axis O2 is referred to as a Z direction. A direction that runs along a plane orthogonal to the optical axis O2 and is parallel to the direction of the optical axis O1 is referred to as a Y direction that is a second direction, and a direction orthogonal to the Y direction is referred to as an X direction that is a first direction. The left and right in the X direction indicate left and right as viewed from a rear side unless otherwise specified.

The digital camera 101 includes a front cover 102 and a rear cover 103 as shown in FIGS. 8 to 10, and a barrel frame unit 120 and a camera control board 118 as shown in FIG. 10. As shown in FIGS. 8 and 9, the front cover 102 and the rear cover 103 are combined together in a mutually facing state so as to form a box-shaped exterior body. The barrel frame unit 120, as shown in FIG. 10, is accommodated inside the front cover 102 and the rear cover 103.

As shown in FIG. 8, a photographing opening window 102d, a light emission window 102e of a flash light emission device, and the like are disposed at a front surface portion of the front cover 102, and a power switch button 115 and a release button 114 are disposed at an upper surface portion of the front cover 102.

As shown in FIG. 9, an operation switch button group 113 for photographing mode setting and the like, a zoom button 117 that directs the zoom operation of the imaging optical system, and an LCD monitor 116 are disposed at the rear surface portion of the rear cover 103.

The camera control board 118 shown in FIG. 10 is a member that performs all the control of the camera, and is assembled into an internal right side of the front cover 102.

The camera control board 118 consists of a printed board on which a CPU, a photographing mode controller, a stroboscope light emission control unit, an image processing unit that performs the processing of photographing image data, a recording control unit that writes the photographing image data in a memory card inserted into the camera, a camera shake detection sensor, and the like are mounted.

As shown in FIG. 11, the barrel frame unit 120 includes a barrel frame body 104 having a flat external shape and serving as a barrel frame, a bending optical system 121 assembled into the barrel frame body 104, and an imaging unit 188 disposed at a lower portion of the barrel frame body 104 in the Z direction.

A CCD 196 (optical member) that is an imaging element is assembled into the imaging unit 188.

As shown in FIG. 12, a rear cover plate 129 that covers the inside of the barrel frame body 104 is attached to a rear side of the barrel frame body 104. The rear cover plate 129 includes locking holes 129a and 129b, and is secured to the barrel frame body 104 by engaging the locking holes 129a and 129b to locking projections (not shown) of the barrel frame body 104.

As shown in FIG. 11, the bending optical system 121 includes a first group front lens 135a, a prism 135b, a first group rear lens 135c, a second group lens 136, a shutter/diaphragm 137, a third group lens 138, and a fourth group lens 139 as optical members.

The first group front lens 135a are lenses that are disposed on the optical axis O1 as a first group lens system in order to make a photographic subject beam incident thereon.

The prism 135b is an optical member that reflects the photographic subject beam incident on the first group front lens 135a toward the optical axis O2.

The first group rear lens 135c are lenses that are disposed on the optical axis O2 at a portion below the prism 135b.

The first group front lens 135a and the first group rear lens 135c constitute a first group lens that is a fixed lens group of the bending optical system 121.

The second group lens 136 is a lens group consisting of two lenses, and is disposed closer to the image side than the first group rear lens 135c along the optical axis O2.

The shutter/diaphragm 137 is a shutter mechanism that operates depending on a control signal from the camera control board 118, is disposed between the second group lens 136 and the third group lens 138 to be described later, and is electrically connected to the camera control board 118.

The shutter/diaphragm 137 is driven to be opened and closed by a shutter/diaphragm driving actuator (not shown) disposed on an upper left side of the barrel frame body 104, on the basis of a control signal from the camera control board 118.

The third group lens 138 is a lens group consisting of two single lenses and one cemented lens, and is disposed closer to the image side than the shutter/diaphragm 137 along the optical axis O2.

The fourth group lens 139 is a lens that constitutes a focal lens in the bending optical system 121, and is disposed between the third group lens 138 and the CCD 196.

As will be described later, the aforementioned respective lens groups are assembled into the barrel frame body 104 of the barrel frame unit 120, and are held by the lens frames, respectively.

The lens frames of the bending optical system 121 include a first group frame 131, a second group frame 132, a third group frame 133, and a fourth group frame 134.

The first group frame 131 is a fixed frame member that holds the first group front lens 135a, the prism 135b, and the first group rear lens 135c therein, and is secured to an upper portion of the barrel frame body 104 with screws.

The second group frame 132 is a substantially tubular movable frame member that holds the second group lens 136 therein, and is provided so as to be movable forward and backward in the direction along the optical axis O2.

The third group frame 133 is a substantially tubular movable frame member that holds the third group lens 138 therein, and is provided so as to be movable forward and backward in the direction along the optical axis O2.

For this reason, as shown in FIG. 13, the second group frame 132 and the third group frame 133 have shaft reception portions 132a and 133a, which allow a metallic guide shaft 141 to be slidably fitted thereinto, at sides thereof. The second group frame 132 and the third group frame 133 are supported inside the barrel frame body 104 in a state (refer to FIG. 15) where the guide shaft 141 is fitted into the shaft reception portions 132a and 133a.

Both ends of the guide shaft 141 are fitted into shaft holes 104a and 104b provided along the Z direction on the right side of the barrel frame body 104, and are secured to the barrel frame body 104.

Additionally, a projection (not shown) is provided on a left portion of the second group frame 132. The projection is slidably engaged with a Z-direction guide portion 104t provided along the Z direction parallel to the optical axis O2 on the left side of the barrel frame body 104. Accordingly, the rotation of the second group frame 132 around the guide shaft 141 is restricted.

Similarly, a projection (not shown) is provided on a left portion of the third group frame 133. The projection is slidably engaged with a Z-direction guide portion 104u provided along the Z direction parallel to the optical axis O2 on the left side of the barrel frame body 104. Accordingly, the rotation of the third group frame 133 around the guide shaft 141 is restricted.

Additionally, an extension spring 143 is suspended from the second group frame 132 and the third group frame 133, and is thereby biased in a direction in which the frames approach each other.

Additionally, driven claws 132b and 133b, which are engaged with a zoom cam 157 provided at the barrel frame body 104 and transmit the movement of the zoom cam 157, are provided in the vicinity of the shaft reception portions 132a and 133a of the second group frame 132 and the third group frame 133.

The zoom cam 157 is disposed along the Z direction on the right of the barrel frame body 104, and is engaged with a zoom driving mechanism 151 coupled to a zoom motor 152 consisting of a DC motor. Accordingly, the zoom cam 157 is rotationally driven in accordance with the movement of the zoom driving mechanism 151.

For this, if the zoom motor 152 is rotationally driven by the camera control board 118 during zoom driving, the zoom cam 157 rotates, and the second group frame 132 and the third group frame 133 are driven forward and backward along the optical axis O2. Accordingly, the second group frame 132 and the third group frame 133 move to their respective zooming positions.

As shown in FIG. 14, the fourth group frame 134 is a substantially tubular movable frame member that holds the fourth group lens 139 therein, and is provided so as to be movable forward and backward in the direction along the optical axis O2.

For this, the fourth group frame 134 has a shaft reception portion 134a, which allows the metallic guide shaft 145 to be slidably fitted thereinto, at a side thereof. The fourth group frame 134 is supported inside the barrel frame body 104 in a state (refer to FIG. 15) where the guide shaft 145 is fitted into the shaft reception portion 134a.

Both ends of the guide shaft 145 are fitted into shaft holes 104c and 104d provided along the Z direction on the left side of the barrel frame body 104, and are secured to the barrel frame body 104.

An extension spring 148 of which one end is locked to the barrel frame body 104 is suspended from the fourth group frame 134, and the fourth group frame 134 is thereby supported in a state where the extension spring, being biased upward in the Z direction.

The fourth group frame 134 is provided with a guide groove 134c. Additionally, the barrel frame body 104 is provided with a guide projection 104g serving as a guide portion and extending in a movement direction (optical axis direction) of the fourth group frame 134. The guide groove 134c and the guide projection 104g mesh with each other such that the fourth group frame is movable in the optical axis direction, and the rotation of the fourth group frame 134 around the optical axis is restricted.

In the barrel frame body 104, a focal motor 149 consisting of a stepping motor is disposed in the vicinity of the guide shaft 145, and a feed screw shaft 146 extending along the Z direction is coupled to an output shaft of the focal motor 149.

A nut 147 is screwed to the feed screw shaft 146.

The nut 147 abuts against an upper surface side of the guide groove 134c of the fourth group frame 134, the feed screw shaft 146 runs through the forth group frame 134. Additionally, the nut 147 has a projection 147b on an outer peripheral portion thereof in the Y direction, and engages with a cutout portion 134b provided in a left portion of the fourth group frame 134 via the projection 147b.

For this reason, the nut 147 is restricted in its rotation around the screw shaft 146 by being engaged with the fourth group frame 134, and is supported so as to be movable in the Z direction in a state where the nut resists the biasing force of the extension spring 148 via the fourth group frame 134.

By virtue of such a configuration, if the focal motor 149 is rotationally driven by the camera control board 118 during the focusing driving, the feed screw shaft 146 rotates, the nut 147 moves in the Z direction, and the fourth group frame 134 is driven forward and backward along the optical axis O2. Accordingly, the fourth group frame 134 moves to its focusing position.

When the power switch button 115 is operated and a power source is turned off, as shown in FIG. 13, the fourth group frame 134 is driven toward the imaging unit 188 downwardly located in the direction of the optical axis O2, and moves to a position extremely close to an opening of the CCD frame 191 of the imaging unit 188.

Additionally, if the power switch button 115 is operated and the power source is turned on, the fourth group frame 134 is driven upward and moves to a focal position separated from the imaging unit 188.

By virtue of such configuration, photographing by the digital camera 101 is possible if the power switch button 115 is operated to turn on the power source.

In order to perform photographing with the digital camera 101, a photographer operates the operation switch button group 113 to set a suitable photographing mode, and frames a photographic subject, for example, by operating the zoom button 117.

When the zoom button 117 is operated, the zoom motor 152 is driven by the camera control board 118, and the zoom cam 157 rotates whereby the second group frame 132 and the third group frame 133 move within the barrel frame body 104. Accordingly, the second group lens 136 and the third group lens 138 that are held by the second group frame 132 and the third group frame 133, respectively, are moved to their zooming positions.

In this case, the engaging portions or the like of the each members slide with each other, respectively. For example, the zoom cam 157 and the driven claws 132b and 133b; the guide shaft 141 and the shaft reception portions 132a and 133a (refer to FIG. 15); the projections of the second group frame 132 and the third group frame 133 and the Z-direction guide portions 104t and 104u; and the like come into contact with each other, and slide with each other.

Next, the photographer half-pushes the release button 114 to perform focusing. When the release button 114 is half-pushed, the focal motor 149 is driven by the camera control board 118, and the feed screw shaft 146 rotates whereby the nut 147 moves forward and backward. Accordingly, the fourth group frame 134 moves within the barrel frame body 104, and the fourth group lens 139 held by the fourth group frame 134 is moved to its focusing position.

In this case, the engaging portions or the like of the respective members slide relative to each other, respectively. For example, the feed screw shaft 146 and the nut 147; the guide shaft 145 and the shaft reception portion 134a (refer to FIG. 15); the projection 147b and the cutout portion 134b; and the like come into contact with each other, and slide relative to each other.

When the fourth group lens 139 moves to its focusing position, AE operation is performed by the camera control board 118 to determine exposure, and the diaphragm value and shutter speed of the shutter/diaphragm 137 are set on the basis of this exposure.

Next, the photographer fully pushes the release button 114. Accordingly, the camera control board 118 controls an imaging operation. Accordingly, photographing of the photographic subject is completed.

When the power switch button 115 is operated and the power source is turned off, the fourth group frame 134 is driven toward the imaging unit 188 located downwardly in the direction of the optical axis O2, and moves to a position extremely close to the opening of the CCD frame 191 of the imaging unit 188.

In this way, in the digital camera 101, various members slide relatively to each other with the movement of the bending optical system 121 in photographing operation. In related-art digital cameras having the similar mechanism, sliding friction is reduced by coating such sliding portions with grease in order to reduce driving friction.

In the present embodiment, similar to the first embodiment, at least one member of relatively sliding members is made as the sliding resin molding product 70. Since the sliding resin molding product 70 (as the first part) contains an additive with friction-reducing property and the additive is appeared on its surface, as least some of greasing can be omitted.

That is, it is configured such that the second part that slides relative to the first part comes into contact with and slide against the first part in a sliding portion without grease being interposed therebetween.

In the barrel frame unit 120 that is the lens barrel of the present embodiment, for example, all of the second group frame 132, the third group frame 133, the fourth group frame 134, the zoom cam 157, and the nut 147 arranged inside the barrel frame body 104 can be made as the first part formed as the aforementioned sliding resin molding product 70.

Additionally, the second part corresponds to all parts that come into contact with the first part and slide relative thereto with the movement of the optical members. In this case, the second part can be made from a resin without a friction reducing additive, or can be made from a metal as in case of the guide shafts 141 and 145.

Additionally, it is preferable to make the second part as the sliding resin molding product 70, that is a product made from a resin with friction-reducing additives appearing on its surface, since friction can be further reduced. For example, as long as required strength is secured even in the guide shafts 141 and 145 and the barrel frame body 104, it is possible to use the sliding resin molding product 70 in these members.

In the following, members that are particularly preferably formed as the sliding resin molding product 70 will be described.

It is preferable that the second group frame 132 is formed as the sliding resin molding product 70. In this case, the frictional coefficient of the surface of the second group frame 132 is low, so that the sliding load between the second group frame 132 and another member that comes into contact with the second group frame 132 and slides relative thereto can be reduced.

Specifically, the sliding resistance between the second group frame 132 (first part), and the guide shaft 141 (second part) and the Z-direction guide portion 104t of the barrel frame body 104 (second part) can be reduced. Accordingly, coating of the lubricant (grease) performed in the related art becomes unnecessary between the second group frame 132, and the guide shaft 141 and the barrel frame body 104.

Since the second group frame 132, and the guide shaft 141 and the Z-direction guide portion 104t of the barrel frame body 104 come into contact with each other without grease, there is no case where the grease volatilizes and is dispersed within the barrel frame body 104, and the lens surfaces become cloudy. For this reason, degradation of imaging performance can be prevented.

It is preferable that the third group frame 133 is formed as the sliding resin molding product 70.

In this case, the frictional coefficient of the surface of the third group frame 133 is low, so that the sliding load between the third group frame 133 and another member that comes into contact with the third group frame 133 and slide relative thereto can be reduced.

Specifically, the sliding resistance between the third group frame 133 (first part), and the guide shaft 141 (second part) and the Z-direction guide portion 104u of the barrel frame body 104 (second part) can be reduced. Accordingly, coating of the lubricant (grease) performed in the related art becomes unnecessary between the third group frame 133, and the guide shaft 141 and the barrel frame body 104.

Since the third group frame 133, and the guide shaft 141 and the Z-direction guide portion 104u of the barrel frame body 104 come into contact with each other without grease, there is no case where the grease volatilizes and is dispersed within the barrel frame body 104, and the lens surfaces become cloudy. For this reason, degradation of imaging performance can be prevented.

It is preferable that the fourth group frame 134 is formed as the sliding resin molding product 70. In this case, the frictional coefficient of the surface of the fourth group frame 134 is low, so that the sliding load between the fourth group frame 134 and another member that comes into contact with the fourth group frame 134 and slides relative thereto can be reduced.

Specifically, the sliding resistance between the fourth group frame 134 (first part), and the guide shaft 145 (second part) and the guide projection 104g of the barrel frame body 104 (second part) can be reduced. Accordingly, coating of the lubricant (grease) performed in the related art becomes unnecessary between the fourth group frame 134, and the guide shaft 145 and the barrel frame body 104.

Since the fourth group frame 134, and the guide shaft 145 and the barrel frame body 104 come into contact with each other without grease, there is no case where the grease volatilizes and is dispersed within the barrel frame body 104, and the lens surfaces become cloudy. For this reason, degradation of imaging performance can be prevented.

Here, the strength of the barrel frame unit 120 of the present embodiment will be described.

When the digital camera 101 is dropped, dropping shock is transmitted to the second group frame 132, the third group frame 133, and the fourth group frame 134 within the barrel frame body 104 after being transmitted to the barrel frame body 104 of the barrel frame unit 120 through the front cover 102 and the rear cover 103.

For example, when shock is applied to the third group frame 133 downward (hereinafter referred to as a Z−(minus) direction), the third group frame 133 moves in the Z− direction. In this case, the third group frame 133 moves in the direction moving away from the zoom cam 157 that is an end cam, and collides against the fourth group frame 134.

Additionally, when shock is applied to the third group frame 133 upward (hereinafter referred to as a Z+ direction), the third group frame 133 moves in the Z+ direction. However, since the third group frame 133 is engaged with and abuts against the zoom cam 157, the third group frame 133 cannot be moved any more. For this reason, a shock load is applied to third group frame 133 itself.

The lens frames, such as the third group frame 133 and the fourth group frame 134, become damaged or deformed due to such shock. For this reason, in the related art, for example, a shock-absorbing member is sandwiched between the lens barrel and a camera body.

However, it is necessary to thicken the shock-absorbing member in order to sufficiently absorb shock, and enlargement of the camera is inevitable.

In contrast, in the present embodiment, it is possible to adopt the sliding resin molding product 70 using the sliding resin containing polyamide in the second group frame 132, the third group frame 133, the fourth group frame 134, and the barrel frame body 104, thereby reducing the sliding resistance without impairing strength. By using the sliding resin containing polyamide, the lubricant (grease) that has been used in the related art becomes unnecessary without causing enlargement of the lens barrel.

In this way, according to the present embodiment, the barrel frame unit 120 is configured such that the first part molded from a resin material to which the additive 72 that reduces friction is added, and the second part come into surface contact with each other and slide relative to each other. For this reason, the driving load can be reduced by virtue of a simple configuration.

Additionally, since such low sliding resistance is obtained without applying coating with grease between the first part and the second part, volatilization of the grease within the lens barrel 2 can be prevented. For this reason, clouding of the optical members in the barrel frame unit 120 and the digital camera 101 can be prevented.

Additionally, even when grease is used for some, not all, sliding portions, the amount of volatilization of the grease can be reduced compared to a case where the grease is used for all sliding portions. In this case, particularly excellent effects are obtained, particularly, by using the sliding resin molding product 70 for the movable frame members near the optical members.

### Third Embodiment

A lens barrel, and a part of the lens barrel in a third embodiment of the present invention will be described.

FIG. 16 is a schematic perspective view showing the external appearance of the lens barrel of the third embodiment of the present invention.

FIG. 17 is a schematic exploded perspective view of the lens barrel of the third embodiment of the present invention. FIG. 18 is a schematic exploded perspective view of the lens barrel of the third embodiment of the present invention as viewed from another direction. FIG. 19 is a schematic sectional view including an optical axis in a collapsed state of the lens barrel of the third embodiment of the present invention. FIG. 20 is a schematic sectional view including the optical axis in a wide state of the lens barrel of the third embodiment of the present invention. FIG. 21 is a schematic sectional view including the optical axis in a collapsed state of the lens barrel of the third embodiment of the present invention.

As shown in FIGS. 16 to 19, a zoom lens barrel 201 that is the lens barrel of the present embodiment is an interchangeable lens that has built thereinto a zoom optical system 203 (refer to FIG. 19) in which a plurality of lenses as optical members are arranged on an optical axis O3.

The zoom lens barrel 201 can be detachably attached to a camera (not shown) by a lens mount sub-assembly 223 (to be described later) provided on one end side in a direction along the optical axis O3.

In the following, a direction or a region near the lens mount sub-assembly 223 in the direction along the optical axis O3 are referred to as the rear, a rear side, or the like, and a direction or a region near an end portion opposite to the lens mount sub-assembly 223 are referred to as the front, a front side, or the like.

The zoom lens barrel 201, as shown in FIG. 17, includes a substantially cylindrical exterior unit 220 and a barrel frame unit 202 built into the exterior unit 220.

The exterior unit 220, as shown in FIG. 19, includes a main frame 225, a focal ring 222, a zoom ring 224, a lens barrel main board 227, and a lens mount sub-assembly 223.

The main frame 225 is a substantially cylindrical member that rotatably holds the focal ring 222 and the zoom ring 224 in the circumferential direction, fixes the lens mount sub-assembly 223, and holds the barrel frame unit 202 therein.

The focal ring 222 is an annular operating member that is provided on a front outer peripheral side (left side shown in FIG. 19) of the exterior unit 220 in order to perform focusing operation, and is rotatably supported on the outer peripheral side of the main frame 225.

A detecting unit (not shown) that detects the rotation of the focal ring 222 is attached to the focal ring 222, and a focal driving mechanism (not shown) is driven according to a signal from the detecting unit.

The zoom ring 224 is an annular operating member that is provided at an intermediate portion in the direction along the optical axis O3 on the outer peripheral side of the exterior unit 220 in order to perform zooming operation, and is rotatably supported on the outer peripheral side of the main frame 225.

The lens barrel main board 227 is a board, such as a flexible board on which electrical components of the zoom lens barrel 201 are mounted, and has a function of performing communication with the camera to perform various kinds of control when the zoom lens barrel 201 is mounted on the camera (not shown).

The lens mount sub-assembly 223 is a coupling member for securing mechanical and electrical connection to the camera (not shown) on which the zoom lens barrel 201 is mounted.

As shown in FIGS. 17 to 19, the barrel frame unit 202 includes a first group lens frame 205 (lens frame), a first group zoom frame 206 (lens frame), a fixed frame 208, a cam frame 207, a second group lens frame 214 (lens frame), a diaphragm unit 213, a third group lens frame 210 (lens frame), a third group zoom frame 211, and a fourth group lens frame 218 (lens frame).

The first group lens frame 205 is a tubular member that holds a first group lens 204 (a lens or an optical member) at an inner peripheral portion thereof.

In the present embodiment, as shown in FIG. 19, the first group lens 204 is a lens group of a three components that has two negative meniscus lenses and one positive meniscus lens from the front side.

The first group zoom frame 206 is a substantially cylindrical member that fixes an outer peripheral portion of the first group lens frame 205 on the front end side, and is supported so as to be movable forward and backward in the direction along the optical axis O3 on the inner peripheral surface of the main frame 225 of the exterior unit 220.

As shown in FIG. 18, a ribbed projection 206a extending in the direction along the optical axis O3 is formed on an inner peripheral portion of the first group zoom frame 206. The projection 206a is engageable with a recess 208b of the fixed frame 208 to be described later.

Additionally, a cam pin 206b for engaging with the cam groove 207a provided in an outer peripheral portion of the cam frame 207 to be described later protrudes radially inward on the rear end side of the inner peripheral portion of the first group zoom frame 206.

As shown in FIG. 19, the fixed frame 208 is a substantially cylindrical frame member that is fixed inside the main frame 225, and does not moved even with zoom operation.

As shown in FIG. 18, a thrust receiving portion 208a, which extends radially outward in order to restrict the movement of the cam frame 207 in the direction along the optical axis O3, is provided at an end portion of the fixed frame 208 on the front side.

An outer peripheral portion of the thrust receiving portion 208a is provided with a recess 208b that is engaged with the projection 206a of the first group zoom frame 206 and restricts the rotation of the first group zoom frame 206 around the optical axis O3.

Additionally, as shown in FIG. 17, rectilinear guide portions 208c and 208d are provided on an outer peripheral surface of the fixed frame 208 in order to restrict the rotation of the second group lens frame 214 and the third group zoom frame 211 around the optical axis O during zoom movement.

The rectilinear guide portions 208c and 208d linearly extend in the direction along the optical axis O3, respectively, consist of slots that penetrate in the radial direction. Cam pins 214a and 211a of the second group lens frame 214 and the third group zoom frame 211 to be described later are slidably fitted thereinto.

The cam frame 207 is a substantially annular cam frame member that moves the second group lens frame 214 and the third group zoom frame 211, in accordance with the zoom operation performed by the zoom ring 224.

The cam frame 207 is coupled to the zoom ring 224 by a coupling member (not shown) so as to rotate integrally therewith.

Cam grooves 207b and 207c that slant with respect to the optical axis O3 are provided on an inner peripheral surface of the cam frame 207 in order to guide the movement of the second group lens frame 214 and the third group zoom frame 211.

The cam frame 207 is externally fitted to an outer peripheral portion of the first group zoom frame 206 so as to be rotatable around the optical axis O3. Additionally, since the cam frame 207 is sandwiched by the thrust receiving portion 208a of the fixed frame 208 and the thrust receiving portion 225a of the main frame 225, the movement thereof in the direction along the optical axis O3 is restricted.

For this reason, although the cam frame 207 is rotatable about the optical axis O3, the cam frame 207 does not move in the direction along the optical axis O3.

As shown in FIG. 17, the second group lens frame 214 is a movable frame member in which three arms are provided at an outer periphery of a cylindrical lens holding portion that holds a second group lens 212 (a lens or an optical member) therein, and is arranged so as to be movable in the direction along the optical axis O3 on the inner side of the fixed frame 208.

The diaphragm unit 213 that constitutes a diaphragm of the zoom optical system 203 is fixed to a front end portion of the second group lens frame 214.

The respective arms of the second group lens frame 214 have an L shape that is bent rearward and extends parallel to the optical axis O3 after extending radially outward from the lens holding portion, respectively, and linear portions after the bending are formed with fitting portions 214b fitted into the rectilinear guide portions 208c of the fixed frame 208.

Cam pins 214a that protrude radially outward are respectively provided at rear ends of the respective fitting portions 214b.

The cam pins 214a are slidably fitted into the cam groove 207b of the cam frame 207.

In the present embodiment, as shown in FIG. 19, the second group lens 212 is a lens group that has a biconvex lens and a cemented lens from the front side.

The third group lens frame 210, as shown in FIG. 19, is a substantially cylindrical movable frame member that holds a third group lens 209 (a lens or an optical member) therein, and a focal driving mechanism including a drive motor is secured to the third group zoom frame 211 (not shown). The third group lens frame 210 is secured to the third group zoom frame 211 via the focal driving mechanism so as to be movable in the optical axis direction.

During zooming, the third group lens frame 210 moves integrally with the third group zoom frame 211 via the focal driving mechanism. Additionally, during focusing, the third group lens frame 210 relatively moves in the optical axis direction with respect to the third group zoom frame 211 by means of the focal driving mechanism.

The third group lens 209 is a focusing lens of the zoom optical system 203. In the present embodiment, as shown in FIG. 19, the third group lens consists of one negative meniscus lens.

The third group zoom frame 211, as shown in FIG. 19, is a tubular movable frame member for moving the third group lens 209 held by the third group lens frame 210 to its zoom position.

The third group lens frame 210 is coupled to an inner peripheral portion of the third group zoom frame 211 via the focal driving mechanism (not shown).

As shown in FIG. 17, an outer peripheral portion of the third group zoom frame 211 is provided with the cam pins 211a that protrude radially outward.

The cam pins 211a are slidably fitted to the cam groove 207c provided in an inner peripheral portion of the cam frame 207.

Additionally, fitting portions 211b slidably fitted to the rectilinear guide portions 208d of the fixed frame 208 are provided near the base of the cam pins 211a.

Accordingly, the third group zoom frame 211 is engaged with the fixed frame 208 so as to be movable in the direction along the optical axis O3 and non-rotatable around the optical axis O3.

By virtue of such a configuration, when the cam frame 207 rotates, the second group lens frame 214 and the third group zoom frame 211 move in the direction along the optical axis O3 along the cam grooves 207b and 207c, respectively. Accordingly, the second group lens 212 held by the second group lens frame 214 and the third group lens 209 held by the third group lens frame 210 that moves together with the third group zoom frame 211 move to their respective zoom positions.

As shown in FIG. 19, the fourth group lens frame 218 is a tubular member that holds a fourth group lens 217 (a lens or an optical member) therein, and is fixed to a rear end portion of the fixed frame 208.

In the present embodiment, the fourth group lens 217 consists of a positive meniscus lens that has a concave surface on the front side.

The first group lens 204, the second group lens 212, the third group lens 209, and the fourth group lens 217 constitute the zoom optical system 203.

By virtue of such a configuration, in the zoom lens barrel 201, it is possible to rotate the zoom ring 224, thereby moving the respective optical members of the zoom optical system 203 to their respective zoom positions from the collapsed state to the wide state and from the wide state to the telephoto state.

Since the projection 206a formed on the first group zoom frame 206 comes into contact with and engages with the recess 208b of the fixed frame 208, the first group zoom frame 206 is movable in the direction along the optical axis O3 and non-rotatable around the optical axis O3. Additionally, the cam pin 206b of the first group zoom frame 206 comes into contact with and slidably engages with the cam groove 207a of the cam frame 207.

For this configuration, the first group zoom frame 206 is moved to a certain position in the direction along the optical axis O3 according to the shape of the cam groove 207a of the cam frame 207 that rotates with the rotation of the zoom ring 224.

Accordingly, the first group lens frame 205 fixed to the first group zoom frame 206 and the first group lens 204 held by the first group lens frame 205 move together with the first group zoom frame 206.

Since the fitting portions 214b are slidably fitted into the rectilinear guide portions 208c of the fixed frame 208, the second group lens frame 214 is movable in the direction along the optical axis O3 and non-rotatable around the optical axis O3. Additionally, the cam pins 214a of the second group lens frame 214 come into contact with and slidably engage with the cam groove 207b of the cam frame 207.

For this configuration, the second group lens frame 214 is moved to a certain position in the direction along the optical axis O3 according to the shape of the cam groove 207b of the cam frame 207 that rotates with the rotation of the zoom ring 2243.

Accordingly, the second group lens 212 held by the second group lens frame 214 moves together with the second group lens frame 214.

Since the fitting portions 211b are slidably fitted into the rectilinear guide portions 208d of the fixed frame 208, the third group zoom frame 211 is movable in the direction along the optical axis O3 and non-rotatable around the optical axis O3. Additionally, the cam pins 211a of the third group zoom frame 211 come into contact with and slidably engage with the cam groove 207c of the cam frame 207.

For this configuration, the third group zoom frame 211 is moved to a certain position in the direction along the optical axis O3 according to the shape of the cam groove 207c of the cam frame 207 that rotates with the rotation of the zoom ring 224.

Accordingly, the third group lens frame 210 secured to the third group zoom frame 211 via the focal moving mechanism (not shown) and the third group lens 209 held by the third group lens frame 210 move together with the third group zoom frame 211.

In the related-art zoom lens barrels, in order to reduce the amount of application forces or secure a sufficient lifespan of products, that is, in order to prevent changes in the amount of application forces caused by repeated operation and the wear of parts caused by the relative sliding of the parts, sliding portions are coated with lubricant. Here, the sliding portions are, for example, portions equivalent to the recess 208b of the fixed frame 208, the rectilinear guide portions 208c and 208d, the fitting portions 211b and 214b, the thrust receiving portion 208a, and the cam grooves 207b and 207c of the cam frame 207, and the like, in the present embodiment.

In the present embodiment, similar to the first embodiment, the coating of at least the portions with grease may be omitted by using at least one member of the members that slide against each other as the first part, which is molded as the sliding resin molding product 70 and which has an additive exposed on the surface thereof.

That is, the second part that slides relative to the first part is configured to come into contact with and slide against the first part in a sliding portion without greasing being interposed therebetween.

In the zoom lens barrel 201 that is the lens barrel of the present embodiment, for example, all of the first group zoom frame 206, the fixed frame 208, the cam frame 207, the second group lens frame 214, and the third group zoom frame 211 can be the first part formed as the aforementioned sliding resin molding product 70. That is, some or all of these frames can be formed as the sliding resin molding product 70.

Additionally, the second part corresponds to all parts that come into contact with the first part and slide relative thereto with the movement of the optical members. In this case, the second part may be made of a resin different from the sliding resin molding product 70, or may be parts other than resin.

Additionally, since friction is further reduced when the sliding resin molding product 70 is also used for the second part, this is more preferable.

In this way, according to the present embodiment, the zoom lens barrel 201 is configured such that the first part molded from a resin material to which the additive 72 that reduces friction is added, and the second part come into surface contact with each other and slide relative each other. For this reason, the driving load can be reduced by virtue of a simple configuration.

Additionally, since such low sliding resistance is obtained without performing coating with grease between the first part and the second part, volatilization of the grease within the barrel frame unit 202 can be prevented. For this reason, clouding of the optical members in the barrel frame unit 202 can be prevented.

Additionally, even when grease is used for some sliding portions, the amount of volatilization of the grease can be reduced compared to a case where the grease is used for all sliding portions. In this case, particularly excellent effects are obtained, particularly, by using the sliding resin molding product 70 for the movable frame members near the optical members.

In addition, the present invention is not limited to the aforementioned respective embodiments, and various modifications can be carried out without departing from the scope of the present invention in the implementation stage. Moreover, present inventions in various implementation stages are included in the aforementioned respective embodiments, and various present inventions can be obtained by suitable combination or elimination of the plurality of constituent elements disclosed.

Although an example in which the imaging optical system has the four-group optical system configuration has been described in the description of the aforementioned first embodiment, the imaging optical system in the lens barrel is not limited to the four-group optical system configuration, and configurations having a plurality of groups other than four groups can be adopted. Additionally, the lens configurations in the respective lens groups according to necessity can also be adopted.

Similarly, the configuration of the imaging optical system of the aforementioned second embodiment and the configuration of the zoom optical system 203 of the aforementioned third embodiment are also not limited to the group configurations and the lens configurations that have been described in the aforementioned respective embodiments, and other well-known group configurations and lens configurations can also be adopted.

Additionally, the camera unit 1 is not limited to being used for compact digital cameras. For example, the camera unit can also be applied as camera units of portable phones with a camera.

Although an example in which the lens barrel 2 has a cylindrical shape as a whole has been described in the description of the aforementioned first embodiment, the shape of the lens barrel is not limited to a cylindrical shape. For example, as in the aforementioned second embodiment, a lens frame of which the outer shape is substantially rectangular like the second group frame 132 or the like may be slidably accommodated, and a tubular member having a substantially rectangular section like the barrel frame body 104 may be included

### EXAMPLES

Next, examples of the aforementioned first and second embodiments will be described together with comparative examples.

The configurations and characteristics of resin materials used with the respective examples and the respective comparative examples are shown in the following Table 1. The configurations and evaluation results of the respective examples and the respective comparative examples are shown in the following Table 2.

TABLE 1

| | Resin 1 | Resin 2 | Resin 3 | Resin 4 |
|---|---|---|---|---|
| Base Resin | Polycarbon- | Polycarbon- | Polyamide | Polycarbon- |
| | ate | ate | | ate |
| Friction- | Organosil- | Fluororesin | Organosil- | None |
| reducing | icone | | icone | |
| additive | | | | |
| Filler | Potassium | Glass fibers | Glass fibers | Glass fibers |
| | titanate | | | |
| Coefficient | 0.1 | 0.2 | 0.2 | 0.4 |
| of dynamic | | | | |
| friction | | | | |
| Bending | 8 | 5 | 15 | 8 |
| elastic | | | | |
| modulus (GPa) | | | | |

TABLE 2

| | | | | Evaluation results |
|---|---|---|---|---|
| | First part | | Second part | Repeated sliding |
| | Member | Resin | Resin | test |
| Example 1 | Float key | Resin 1 | Resin 4 | ◯ |
| Example 2 | Cam frame | Resin 1 | Resin 1 | ◯ |
| Example 3 | Fourth group | Resin 1 | Resin 4 | ◯ |
| | frame | | | |
| Example 4 | Float key | Resin 2 | Resin 4 | ◯ |
| Example 5 | Rotary frame | Resin 3 | Resin 4 | ◯ |
| Example 6 | Rotary frame | Resin 3 | Resin 3 | ◯ |
| Example 7 | Movable Frame | Resin 3 | Resin 4 | ◯ |
| Example 8 | Second group | Resin 1 | Shaft (metal) | ◯ |
| | frame | | | |
| Example 9 | Third group | Resin 2 | Shaft (metal) | ◯ |
| | frame | | | |
| Example 10 | Second group | Resin 3 | Shaft (metal) | ◯ |
| | frame | | | |
| Example 11 | Fixed frame | Resin 1 | Resin 4 | ◯ |
| Example 12 | Cam frame, | Resin 1 | Resin 4 | ◯ |
| | Fixed frame | | | |
| Example 13 | Cam frame, | Resin 2 | Resin 4 | ◯ |
| | Fixed frame | | | |
| Example 14 | Cam frame, | Resin 3 | Resin 4 | ◯ |
| | Fixed frame | | | |
| Comparative | Float key | Resin 4 | Resin 4 | X |
| Example 1 | | | | |
| Comparative | Second group | Resin 4 | Shaft (metal) | X |
| Example 2 | frame | | | |

Resins 1 to 3 shown in Table 1 are examples of the sliding resin that constitutes the sliding resin molding product 70 in the aforementioned respective embodiments, and Resin 4 is an example of a resin that is different from the sliding resin in the aforementioned respective embodiments.

In Resin 1, the base resin 71 consisted of polycarbonate, and the additive 72 consists of organosilicones including an organosilicon compound. Potassium titanate as a filler for improving resin strength was added to Resin 1.

In Resin 1, the coefficient of dynamic friction was 0.1, and the bending elastic modulus was 8 GPa.

In Resin 2, the base resin 71 consists of polycarbonate, and the additive 72 consists of fluororesins including a fluorine compound. Glass fibers as a filler for improving the resin strength were added to Resin 2.

In Resin 2, the coefficient of dynamic friction was 0.2, and the bending elastic modulus was 5 GPa.

In Resin 3, the base resin 71 consists of polyamide, and the additive 72 consisted of organosilicone. Glass fibers for improving the resin strength using a filler were added to Resin 3.

In Resin 3, the coefficient of dynamic friction was 0.2, and the bending elastic modulus was 15 GPa.

Resin 4 is an example in which the additive 72 that reduces friction is not added to Resin 2. In Resin 4, glass fibers were added as a filler to polycarbonate as the base resin.

In Resin 4, the coefficient of dynamic friction was 0.4, and the bending elastic modulus was 8 GPa.

### Examples 1 to 7

Examples 1 to 7 are examples of the lens barrel 2 of the aforementioned first embodiment.

In Example 1, the float key 9 that is the first part was formed of Resin 1, the cam frame 5, the third group frame 7, and the second group frame 6 that are the second part were formed of Resin 4, and the other resin members were formed of Resin 4.

In Example 2, the cam frame 5 that is the first part was formed of Resin 1, the float key 9 that is the second part was formed of Resin 1, and the other resin members were formed of Resin 4. For this reason, the present example is an example in which both of the first part and the second part are formed as the sliding resin molding product 70.

In Example 3, the fourth group frame 12 that is the first part was formed of Resin 1, the fixed frame 13 that is the second part was formed of Resin 4, and the other resin members were formed of Resin 4.

Example 4 is different from Example 1 only in that the float key 9 was formed of Resin 2 in the aforementioned Example 1.

In Example 5, the rotary frame 11 that is the first part was formed of Resin 3, the movable frame 10 and the fixed frame 13 that are the second part were formed of Resin 4, and the other resin members were formed of Resin 4.

Example 6 is different from Example 5 only in that the second part was formed of Resin 3 in the aforementioned Example 5.

In Example 7, the movable frame 10 that is the first part was formed of Resin 3, the rotary frame 11 that is the second part was formed of Resin 4, and the other resin members were formed of Resin 4.

### Examples 8 to 10

Examples 8 to 10 are examples of the barrel frame unit 120 of the aforementioned second embodiment.

In Example 8, the second group frame 132 that is the first part was formed of Resin 1, the guide shaft 141 that is the second part was formed of metal consisting of SUS (stainless steel), and the third group frame 133 was formed of Resin 4.

In Example 9, the third group frame 133 that is the first part was formed of Resin 2, the guide shaft 141 that is the second part was formed of metal consisting of SUS, and the second group frame 132 was formed of Resin 4.

Example 10 is different from Example 8 only in that the second group frame 132 was formed of Resin 3 in the aforementioned Example 8.

Examples 11 to 14 are examples of the zoom lens barrel 201 of the aforementioned third embodiment.

In Example 11, the fixed frame 208 that is the first part was formed of Resin 1, and the cam frame 207, the second group lens frame 214, and the third group zoom frame 211 that are a second part was formed of Resin 4.

In Example 12, the cam frame 207 and the fixed frame 208 that are the first part was formed of Resin 1, and the second group lens frame 214, the third group zoom frame 211, and the first group zoom frame 206 that are the second part was formed of Resin 4.

Example 13 is different from Example 12 only in that the cam frame 207 and the fixed frame 208 that are the first part was formed of Resin 2 in the aforementioned Example 12.

Example 14 is different from Example 12 only in that the cam frame 207 and the fixed frame 208 that are the first part was formed of Resin 3 in the aforementioned Example 12.

### Comparative Examples 1 and 2

Comparative Example 1 is different from Example 1 only in that the float key 9 was formed of Resin 4 in the aforementioned Example 1.

Comparative Example 2 is different from Example 8 only in that the second group frame 132 was formed of Resin 4 in the aforementioned Example 8.

Evaluation Methods

Evaluation was performed by manufacturing camera units and zoom lens barrels including the lens barrels and the barrel frame units of the respective examples and the respective comparative examples and performing repeated sliding tests of repeating a zooming operation 30,000 times. Whether the zoom lens barrels operated normally was evaluated after the end of the tests.

Evaluation Results

The evaluation results of the repeated sliding tests are shown in Table 2. In Table 2, “O (good)” represents that a zoom lens barrels could operate normally, and “x (poor)” represents that a zoom lens barrel could not operate normally.

As shown in Table 2, the evaluation results of Examples 1 to 14 were all “O”.

In contrast, the evaluation results were “x” in Comparative Examples 1 and 2 because the zoom lens barrels could not operate normally.

Thus, according to Examples 1 to 14, the first part is formed as the sliding resin molding product 70. Therefore, it can be seen that, the sliding load is reduced and even if sliding portions are not coated with grease, excellent durability is exhibited.

While preferred embodiments of the present invention have been described, the present invention is not limited to the embodiments.

Additions, omissions and substitutions, and other variations may be made to the present invention without departing from the spirit and scope of the present invention. The present invention is not limited only by the aforementioned description, but by the appended claims.

What is claimed is:

1. A lens barrel accommodating an optical member including a lens such that the optical member is movable in a direction of an optical axis of the optical member, the lens barrel comprising:
a first part configured to move when the optical member moves in the direction of the optical axis, the first part being molded of a resin material in which an additive including organosilicon compound with a friction-reducing property is added to a base resin, the additive being exposed on a surface of the base resin; and
a second part being in contact with the surface of the first part, the second part relatively sliding on the surface of the first part when the optical member moves in the direction of the optical axis.

2. The lens barrel according to claim 1,
wherein the first part is one of a lens frame that secures the lens and a part being in contact with the lens frame.

3. The lens barrel according to claim 1,
wherein the additive contains organosilicone.

4. The lens barrel according to claim 1,
wherein the second part is molded of a resin material in which an additive with a friction-reducing property is added to a base resin, and the additive being exposed on a surface of the base resin.

5. The lens barrel according to claim 1,
wherein the base resin contains at least one of polycarbonate and polyamide.

6. The lens barrel according to claim 1,
wherein a coefficient of dynamic friction of the first part under a load of 20 g is equal to or lower than 0.2.

7. The lens barrel according to claim 1,
wherein a bending elastic modulus of the first part is equal to or higher than 6 GPa.

8. An imaging device comprising:
the lens barrel according to claim 1.

9. A part of a lens barrel that accommodates an optical member including a lens such that the optical member is movable in a direction of an optical axis of the optical member,
wherein the part is made of a material including a base resin,
wherein an additive having a friction-reducing property is added to the base resin and the additive is exposed on a surface of the base resin, and
wherein, being accommodated in the lens barrel, the part is in contact with another part of the lens barrel on the surface on which the additive is exposed, the another part relatively slides on the part when the optical member moves in a direction of the optical axis.

10. The part of a lens barrel according to claim 9,
wherein the surface of the part of a lens barrel is configured such that a coefficient of dynamic friction under a load of 20 g is equal to or lower than 0.2.

11. A lens barrel that accommodates an optical member including a lens such that the optical member is movable in a direction of an optical axis of the optical member,
wherein the lens barrel has a plurality of sliding parts that slides on another part when the optical member moves in a direction of the optical axis and that made of resin;
at least one of the plurality of sliding parts is formed by adding an additive to the resin such that a coefficient of dynamic friction of a surface of the at least one of sliding parts becomes equal to or lower than 0.2 under a load of 20 g; and
no lubricant is applied on the surface of the at least one of sliding parts.

12. The lens barrel according to claim 1,
wherein no lubricant is applied on a sliding surface on which the first part and the second part slide against each other.

13. The lens barrel according to claim 12,
wherein at least portions of the sliding surface on which the first part and the second part slide against each other with the movement of the optical member in an direction of an optical axis of the optical member is exposed to the optical member.

14. The lens barrel according to claim 1,
wherein the first part is not exposed to the outside of the lens barrel.
